(19) United States
(12) Patent Application Publication
(10) Pub. No.: US 2026/0188207 A1
(43) Pub. Date: Jul. 2, 2026

(54) PIXEL CIRCUIT AND DRIVING METHOD THEREFOR, DISPLAY PANEL, AND DISPLAY DEVICE

(71) Applicants: BEIJING BOE TECHNOLOGY DEVELOPMENT CO., LTD., Beijing (CN); BOE TECHNOLOGY GROUP CO., LTD., Beijing (CN)

(72) Inventors: Miao LIU, Beijing (CN); Lang LIU, Beijing (CN); Teng CHEN, Beijing (CN); Xueguang HAO, Beijing (CN); Yong QIAO, Beijing (CN); Jingquan WANG, Beijing (CN); Xinyin WU, Beijing (CN)

(21) Appl. No.: 18/695,579

(22) PCT Filed: Jun. 30, 2023
(86) PCT No.: PCT/CN2023/105030

§ 371 Date: Mar. 18, 2026

(30) Foreign Application Priority Data
Aug. 23, 2022 (CN) 202211012901.3

(51) Int. Cl. G09G 3/3233

(52) U.S. Cl. CPC G09G 3/3233; G09G 2300/043; G09G 2300/0819; G09G 2300/0842; G09G 2310/08; G09G 2330/023

(57) ABSTRACT

A pixel circuit and a driving method therefor, a display panel, and a display device are provided. In the pixel circuit, a control terminal of the driving circuit is connected with the storage circuit at a first node, and the first light emission control circuit is connected with the first terminal of the driving circuit at a second node. The method includes: before a data writing phase, the first reset circuit turning on to reset the first node, and the first light emission control circuit turning on to reset the second node; during the data writing phase, the data writing circuit turning on, so as to write the data signal into the first terminal of the driving circuit; and during a light emitting phase, the first light emission control circuit turning on, and the light emitting element emitting light according to the drive current.

The present application claims priority of Chinese Patent Application No. 202211012901.3, filed on Aug. 23, 2022, the disclosure of which is hereby incorporated herein by reference in its entirety as part of the present disclosure.

### TECHNICAL FIELD

Embodiments of the present disclosure relate to a pixel circuit and a driving method therefor, a display panel, and a display device.

### BACKGROUND

Organic light emitting diode (OLED) display devices have gradually received widespread attention due to their advantages such as wide viewing angle, high contrast ratio, fast response speed, higher light emission brightness and lower driving voltage than inorganic light emitting display devices. Due to the above-described characteristics, the organic light emitting diodes (OLEDs) can be applied to apparatuses having a display function such as mobile phones, monitors, tablet personal computers, digital cameras, instruments, and so on.

The pixel circuit in the OLED display device usually adopts a matrix drive mode, which includes active matrix (AM) drive and passive matrix (PM) drive according to whether switch components are introduced in each pixel unit. Although the PMOLED has simple process and low costs, it cannot meet the needs of high-resolution large-sized display due to drawbacks such as cross talk, high power consumption, and low lifespan. In contrast, the AMOLED integrates a group of thin film transistors and a storage capacitor in the pixel circuit of each pixel, and controls a current flowing through the OLED by performing drive control on the thin film transistors and the storage capacitor, thereby allowing the OLED to emit light as needed. As compared with the PMOLED, the AMOLED has low drive current requirement, low power consumption, and longer lifespan, which can meet the needs of high-resolution multi-grayscale large-sized display. Meanwhile, the AMOLED has significant advantages in visual angle, color restoration, power consumption, and response time, etc., making it suitable for a display device with high information content and high resolution.

### SUMMARY

At least one embodiment of the present disclosure provides a method for driving a pixel circuit. The pixel circuit comprises a driving circuit, a data writing circuit, a threshold compensating circuit, a storage circuit, a first light emission control circuit, and a first reset circuit. The driving circuit comprises a control terminal, a first terminal, and a second terminal, and is configured to control a drive current flowing through a light emitting element. The data writing circuit is connected with the first terminal of the driving circuit, and is configured to write a data signal into the first terminal of the driving circuit in response to a first scanning signal. The threshold compensating circuit is connected between the control terminal of the driving circuit and the second terminal of the driving circuit, and is configured to write a compensation signal based on the data signal into the control terminal of the driving circuit in response to a second scanning signal. The storage circuit is connected with the control terminal of the driving circuit and a first voltage line, and is configured to store the compensation signal and keep the compensation signal at the control terminal of the driving circuit. The first light emission control circuit is connected with the first voltage line and the first terminal of the driving circuit, and is configured to apply a first voltage supplied by the first voltage line to the first terminal of the driving circuit in response to a first light emission control signal. The first reset circuit is connected with the threshold compensating circuit, and is configured to apply a first reset voltage to the control terminal of the driving circuit in response to a first reset signal. The control terminal of the driving circuit is connected with the storage circuit at a first node, and the first light emission control circuit is connected with the first terminal of the driving circuit at a second node. The method comprises: before a data writing phase, the first reset circuit turning on in response to the first reset signal to apply the first reset voltage to the control terminal of the driving circuit, so as to reset the first node, and the first light emission control circuit turning on in response to the first light emission control signal to apply the first voltage to the first terminal of the driving circuit, so as to reset the second node; during the data writing phase, the data writing circuit turning on in response to the first scanning signal, so as to write the data signal into the first terminal of the driving circuit; and during a light emitting phase, the first light emission control circuit turning on in response to the first light emission control signal, and the light emitting element emitting light according to the drive current.

For example, in the method provided by an embodiment of the present disclosure, the first reset circuit turning on in response to the first reset signal to apply the first reset voltage to the control terminal of the driving circuit, so as to reset the first node, comprises: the first reset circuit turning on in response to the first reset signal, and the threshold compensating circuit turning on in response to the second scanning signal, to apply the first reset voltage to the control terminal of the driving circuit through a path formed by the first reset circuit and the threshold compensating circuit, so as to reset the first node.

For example, in the method provided by an embodiment of the present disclosure, the pixel circuit further comprises a second light emission control circuit and a second reset circuit. The second light emission control circuit is connected with the second terminal of the driving circuit and the light emitting element, and is configured to apply a voltage of the second terminal of the driving circuit to the light emitting element in response to a second light emission control signal. The second reset circuit is connected with the second light emission control circuit and the light emitting element, and is configured to apply a second reset voltage to the light emitting element in response to a second reset signal. The second light emission control circuit is connected with the second terminal of the driving circuit at a third node, and the second reset circuit is connected with the second light emission control circuit and the light emitting element at a fourth node. The method further comprises: before the data writing phase, the first reset circuit applying the first reset voltage to the second terminal of the driving circuit while the first reset circuit resets the first node, so as to reset the third node; and/or before the data writing phase, the second reset circuit turning on in response to the second reset signal, to apply the second reset voltage to the light emitting element, so as to reset the fourth node.

For example, in the method provided by an embodiment of the present disclosure, before the data writing phase, the first node and the second node are reset simultaneously, or reset separately in different time periods.

For example, in the method provided by an embodiment of the present disclosure, before the data writing phase, in the case of resetting both the third node and the fourth node, the third node and the fourth node are reset simultaneously, or reset separately in different time periods.

For example, in the method provided by an embodiment of the present disclosure, before the data writing phase, a reset period of at least one of the third node or the fourth node coincides with a reset period of at least one of the first node or the second node.

For example, in the method provided by an embodiment of the present disclosure, before the data writing phase, none of a reset period of the first node, a reset period of the second node, a reset period of the third node, and a reset period of the fourth node coincides.

For example, the method provided by an embodiment of the present disclosure further comprises: after the data writing phase and before the light emitting phase, the first light emission control circuit turning on in response to the first light emission control signal, to apply the first voltage to the first terminal of the driving circuit, so as to reset the second node; and/or, after the data writing phase and before the light emitting phase, the first reset circuit turning on in response to the first reset signal, to apply the first reset voltage to the second terminal of the driving circuit, so as to reset the third node; and/or, after the data writing phase and before the light emitting phase, the second reset circuit turning on in response to the second reset signal, to apply the second reset voltage to the light emitting element, so as to reset the fourth node.

For example, in the method provided by an embodiment of the present disclosure, after the data writing phase and before the light emitting phase, at least two nodes among the second node, the third node, and the fourth node are reset simultaneously, or reset separately in different time periods.

For example, in the method provided by an embodiment of the present disclosure, the driving circuit comprises a driving transistor, the data writing circuit comprises a data writing transistor, the threshold compensating circuit comprises a threshold compensating transistor, the first light emission control circuit comprises a first light emission control transistor, and the first reset circuit comprises a first reset transistor; the driving transistor, the data writing transistor, the first light emission control transistor, and the first reset transistor are transistors of a first type; the threshold compensating transistor is a transistor of a second type; and the first type is different from the second type.

For example, in the method provided by an embodiment of the present disclosure, the transistors of the first type comprise P-type thin film transistors, and the transistor of the second type comprises an N-type thin film transistor.

For example, in the method provided by an embodiment of the present disclosure, the pixel circuit further comprises an anti-creeping circuit, the anti-creeping circuit is connected with the control terminal of the driving circuit, the threshold compensating circuit, and the storage circuit, and the anti-creeping circuit is configured to suppress electric leakage at the control terminal of the driving circuit.

For example, in the method provided by an embodiment of the present disclosure, the anti-creeping circuit comprises an anti-creeping transistor, and the anti-creeping transistor is a transistor of the second type.

At least one embodiment of the present disclosure further provides a pixel circuit, which comprises: a driving circuit, a data writing circuit, a threshold compensating circuit, a storage circuit, and a first reset circuit. The driving circuit comprises a control terminal, a first terminal, and a second terminal, and is configured to control a drive current flowing through the light emitting element; the data writing circuit is connected with the first terminal of the driving circuit, and is configured to write a data signal into the first terminal of the driving circuit in response to a first scanning signal; the threshold compensating circuit is connected between the control terminal of the driving circuit and the second terminal of the driving circuit, and is configured to write a compensation signal based on the data signal into the control terminal of the driving circuit in response to a second scanning signal; the storage circuit is connected with the control terminal of the driving circuit and a first voltage line, and is configured to store the compensation signal and keep the compensation signal at the control terminal of the driving circuit, and the control terminal of the driving circuit is connected with the storage circuit at a first node; the first reset circuit is connected with the threshold compensating circuit and the second terminal of the driving circuit, and is configured to apply a first reset voltage to the second terminal of the driving circuit in response to a first reset signal.

For example, in the pixel circuit provided by an embodiment of the present disclosure, the driving circuit comprises a driving transistor, a gate electrode of the driving transistor serves as the control terminal of the driving circuit, a first electrode of the driving transistor serves as the first terminal of the driving circuit, and a second electrode of the driving transistor serves as the second terminal of the driving circuit; the data writing circuit comprises a data writing transistor, a gate electrode of the data writing transistor is connected with a first scanning line to receive the first scanning signal, a first electrode of the data writing transistor is connected with a data line to receive the data signal, and a second electrode of the data writing transistor is connected with the first electrode of the driving transistor; the threshold compensating circuit comprises a threshold compensating transistor, a gate electrode of the threshold compensating transistor is connected with a second scanning line to receive the second scanning signal, a first electrode of the threshold compensating transistor is connected with the second electrode of the driving transistor, and a second electrode of the threshold compensating transistor is connected with the gate electrode of the driving transistor; the storage circuit comprises a storage capacitor, a first electrode of the storage capacitor is connected with the first voltage line, and a second electrode of the storage capacitor is connected with the gate electrode of the driving transistor; and the first reset circuit comprises a first reset transistor, a gate electrode of the first reset transistor is connected with a first reset line to receive the first reset signal, a first electrode of the first reset transistor is connected with a first reset voltage line to receive the first reset voltage, and a second electrode of the first reset transistor is connected with the second electrode of the driving transistor.

For example, the pixel circuit provided by an embodiment of the present disclosure further comprises a first light emission control circuit and a second light emission control circuit. The first light emission control circuit is connected with the first voltage line and the first terminal of the driving circuit, and is configured to apply a first voltage supplied by the first voltage line to the first terminal of the driving circuit in response to a first light emission control signal, and the first light emission control circuit is connected with the first terminal of the driving circuit at a second node; and the second light emission control circuit is connected with the second terminal of the driving circuit and the light emitting element, and is configured to apply a voltage of the second terminal of the driving circuit to the light emitting element in response to a second light emission control signal, and the second light emission control circuit is connected with the second terminal of the driving circuit at a third node.

For example, in the pixel circuit provided by an embodiment of the present disclosure, the first light emission control circuit comprises a first light emission control transistor, a gate electrode of the first light emission control transistor is connected with a first light emission control line to receive the first light emission control signal, a first electrode of the first light emission control transistor is connected with the first voltage line, and a second electrode of the first light emission control transistor is connected with the first terminal of the driving circuit; and the second light emission control circuit comprises a second light emission control transistor, a gate electrode of the second light emission control transistor is connected with a second light emission control line to receive the second light emission control signal, a first electrode of the second light emission control transistor is connected with the second terminal of the driving circuit, and a second electrode of the second light emission control transistor is connected with the light emitting element.

For example, the pixel circuit provided by an embodiment of the present disclosure further comprises a second reset circuit. The second reset circuit is connected with the second light emission control circuit and the light emitting element, and is configured to apply a second reset voltage to the light emitting element in response to a second reset signal; the second reset circuit is connected with the second light emission control circuit and the light emitting element at a fourth node; and a potential of the third node after being reset by the first reset circuit is greater than a potential of the fourth node after being reset by the second reset circuit.

For example, in the pixel circuit provided by an embodiment of the present disclosure, the second reset circuit comprises a second reset transistor, a gate electrode of the second reset transistor is connected with a second reset line to receive the second reset signal, a first electrode of the second reset transistor is connected with a second reset voltage line to receive the second reset voltage, and a second electrode of the second reset transistor is connected with the second electrode of the second light emission control transistor and the light emitting element.

For example, the pixel circuit provided by an embodiment of the present disclosure further comprises a third reset circuit. The third reset circuit is connected with the threshold compensating circuit and the control terminal of the driving circuit, the third reset circuit is configured to apply a third reset voltage to the control terminal of the driving circuit in response to a third reset signal; a potential of the first node after being reset by the third reset circuit is less than the potential of the third node after being reset by the first reset circuit; and the potential of the first node after being reset by the third reset circuit is less than or equal to the potential of the fourth node after being reset by the second reset circuit.

For example, in the pixel circuit provided by an embodiment of the present disclosure, the third reset circuit comprises a third reset transistor, a gate electrode of the third reset transistor is connected with a third reset line to receive the third reset signal, a first electrode of the third reset transistor is connected with a third reset voltage line to receive the third reset voltage, and a second electrode of the third reset transistor is connected with the control terminal of the driving circuit.

For example, the pixel circuit provided by an embodiment of the present disclosure further comprises a fourth reset circuit. The fourth reset circuit is connected with the first terminal of the driving circuit, and the fourth reset circuit is configured to apply a fourth reset voltage to the first terminal of the driving circuit in response to a fourth reset signal; a potential of the second node after being reset by the fourth reset circuit is greater than the potential of the first node after being reset by the third reset circuit; the potential of the second node after being reset by the fourth reset circuit is greater than the potential of the third node after being reset by the first reset circuit; and the potential of the second node after being reset by the fourth reset circuit is greater than the potential of the fourth node after being reset by the second reset circuit.

For example, in the pixel circuit provided by an embodiment of the present disclosure, the fourth reset circuit comprises a fourth reset transistor, a gate electrode of the fourth reset transistor is connected with a fourth reset line to receive the fourth reset signal, a first electrode of the fourth reset transistor is connected with a fourth reset voltage line to receive the fourth reset voltage, and a second electrode of the fourth reset transistor is connected with the first terminal of the driving circuit.

At least one embodiment of the present disclosure further provides a display panel, which comprises a plurality of pixel units. Each pixel unit comprises the pixel circuit provided by any one of the embodiments of the present disclosure.

At least one embodiment of the present disclosure further provides a display device, which comprises the display panel provided by any one of the embodiments of the present disclosure.

### BRIEF DESCRIPTION OF THE DRAWINGS

In order to clearly illustrate the technical solution of the embodiments of the present disclosure, the drawings of the embodiments will be briefly described. It is obvious that the described drawings in the following are only related to some embodiments of the present disclosure and thus are not limitative of the present disclosure.

FIG. 1A is a schematic diagram of a 2T1C pixel circuit;

FIG. 1B is a schematic diagram of another 2T1C pixel circuit;

FIG. 2 is a schematic block diagram of a pixel circuit provided by some embodiments of the present disclosure;

FIG. 3 is a schematic block diagram of another pixel circuit provided by some embodiments of the present disclosure;

FIG. 4 is a schematic block diagram of another pixel circuit provided by some embodiments of the present disclosure;

FIG. 5 is a schematic block diagram of another pixel circuit provided by some embodiments of the present disclosure;

FIG. 6 is a schematic flow chart of a method for driving a pixel circuit provided by some embodiments of the present disclosure;

FIG. 7 is a schematic diagram of a circuit structure of the pixel circuit illustrated in FIG. 2;

FIG. 8 is a timing diagram for the pixel circuit illustrated in FIG. 7 provided by some embodiments of the present disclosure;

FIG. 9 is a timing diagram of a first voltage provided by some embodiments of the present disclosure;

FIG. 10 is another timing diagram for the pixel circuit illustrated in FIG. 7 provided by some embodiments of the present disclosure;

FIG. 11 is another timing diagram for the pixel circuit illustrated in FIG. 7 provided by some embodiments of the present disclosure;

FIG. 12 is a schematic diagram of a circuit structure of the pixel circuit illustrated in FIG. 5;

FIG. 13 is a timing diagram for the pixel circuit illustrated in FIG. 12 provided by some embodiments of the present disclosure;

FIG. 14 is another timing diagram for the pixel circuit illustrated in FIG. 12 provided by some embodiments of the present disclosure;

FIG. 15 is another timing diagram for the pixel circuit illustrated in FIG. 12 provided by some embodiments of the present disclosure;

FIG. 16 is another timing diagram for the pixel circuit illustrated in FIG. 12 provided by some embodiments of the present disclosure;

FIG. 17 is a schematic diagram of a circuit structure of the pixel circuit illustrated in FIG. 3;

FIG. 18 is a timing diagram for the pixel circuit illustrated in FIG. 17 provided by some embodiments of the present disclosure;

FIG. 19 is another timing diagram for the pixel circuit illustrated in FIG. 17 provided by some embodiments of the present disclosure;

FIG. 20 is another timing diagram for the pixel circuit illustrated in FIG. 17 provided by some embodiments of the present disclosure;

FIG. 21 is a schematic diagram of a circuit structure of the pixel circuit illustrated in FIG. 4;

FIG. 22 is a timing diagram for the pixel circuit illustrated in FIG. 21 provided by some embodiments of the present disclosure;

FIG. 23 is a schematic diagram of a circuit structure of a pixel circuit provided by some embodiments of the present disclosure;

FIG. 24 is a timing diagram for the pixel circuit illustrated in FIG. 23 provided by some embodiments of the present disclosure;

FIG. 25 is a schematic block diagram of a display panel provided by some embodiments of the present disclosure; and

FIG. 26 is a schematic block diagram of a display device provided by some embodiments of the present disclosure.

### DETAILED DESCRIPTION

In order to make objects, technical details and advantages of the embodiments of the present disclosure apparent, the technical solutions of the embodiments will be described in a clearly and fully understandable way in connection with the drawings related to the embodiments of the present disclosure. Apparently, the described embodiments are just a part but not all of the embodiments of the present disclosure. Based on the described embodiments herein, those skilled in the art can obtain other embodiment(s), without any inventive work, which should be within the scope of the present disclosure.

Unless otherwise defined, all the technical and scientific terms used herein have the same meanings as commonly understood by one of ordinary skill in the art to which the present disclosure belongs. The terms “first,” “second,” etc., which are used in the present disclosure, are not intended to indicate any sequence, amount or importance, but distinguish various components. Also, the terms “one”, “a”, or “the” etc. do not indicate a quantity limit, but rather indicate the existence of at least one. The terms “comprise,” “comprising,” “include,” “including,” etc., are intended to specify that the elements or the objects stated before these terms encompass the elements or the objects and equivalents thereof listed after these terms, but do not preclude the other elements or objects. The phrases “connect”, “connected”, etc., are not intended to define a physical connection or mechanical connection, but may include an electrical connection, directly or indirectly. “On,” “under,” “right,” “left” and the like are only used to indicate relative position relationship, and when the position of the object which is described is changed, the relative position relationship may be changed accordingly.

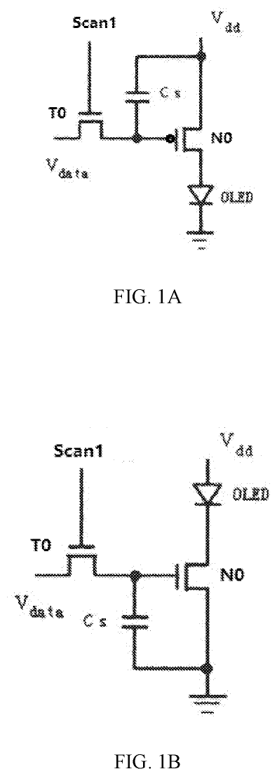

The basic pixel circuit used in the AMOLED display device is usually a 2T1C pixel circuit, that is, two thin-film transistors (TFTs) and one storage capacitor Cs are utilized to implement a basic function of driving the OLED to emit light. FIG. 1A and FIG. 1B are schematic diagrams illustrating two types of 2T1C pixel circuit, respectively.

As illustrated in FIG. 1A, one type of 2T1C pixel circuit includes a switch transistor T0, a driving transistor N0 and a storage capacitor Cs. For example, a gate electrode of the switch transistor T0 is connected with a scanning line to receive a scanning signal Scan1, for example, a source electrode is coupled to a data line to receive a data signal Vdata, and a drain electrode is coupled to a gate electrode of the driving transistor N0. A source electrode of the driving transistor N0 is coupled to a first voltage terminal to receive a first voltage Vdd (e.g., a high voltage), and a drain electrode is coupled to an anode of an OLED. One terminal of the storage capacitor Cs is coupled to the drain electrode of the switch transistor T0 and the gate electrode of the driving transistor N0, and the other terminal is coupled to the source electrode of the driving transistor N0 and the first voltage terminal. A cathode of the OLED is coupled to a second voltage terminal to receive a second voltage Vss (a low voltage, for example, a ground voltage).

The driving mode of this 2T1C pixel circuit is to control brightness (gray scales) of pixels through two TFTs and one storage capacitor Cs. When the scanning signal Scan1 is applied through the scanning line to turn on the switch transistor T0, a data driving circuit may charge the storage capacitor Cs via the switch transistor T0 through the data signal Vdata sent by the data line, thereby storing the data signal Vdata in the storage capacitor Cs. The stored data signal Vdata controls the conduction degree of the driving transistor N0, thereby controlling the magnitude of a current flowing through the driving transistor to drive the OLED to emit light, that is, this current determines the gray scale at which the pixel emits light. In the 2T1C pixel circuit illustrated in FIG. 1A, the switch transistor T0 is an N-type transistor and the driving transistor N0 is a P-type transistor.

As illustrated in FIG. 1B, the other type of 2T1C pixel circuit also includes a switch transistor T0, a driving transistor N0 and a storage capacitor Cs. However, the connection mode thereof is slightly changed, and the driving transistor N0 is an N-type transistor. Changes in the pixel circuit of FIG. 1B as compared with FIG. 1A include that: an anode of the OLED is coupled to a first voltage terminal to receive a first voltage Vdd (e.g., a high voltage), and a cathode is coupled to a drain electrode of the driving transistor N0, a source electrode of the driving transistor N0 is coupled to a second voltage terminal to receive a second voltage Vss (a low voltage, for example, a ground voltage). One terminal of the storage capacitor Cs is coupled to a drain electrode of the switch transistor T0 and a gate electrode of the driving transistor N0, and the other terminal is coupled to the source electrode of the driving transistor N0 and the second voltage terminal. The operation mode of this 2T1C pixel circuit is basically the same as the pixel circuit illustrated in FIG. 1A, and no details will be repeated here.

In addition, with respect to the pixel circuits illustrated in FIG. 1A and FIG. 1B, the switch transistor T0 is not limited to an N-type transistor, but may also be a P-type transistor, and thus, it is needed to accordingly change polarities of the scanning signal Scan1 that controls turn-on state or turn-off state thereof.

The OLED display device usually includes a plurality of pixel units arranged in an array, and each pixel unit, for example, may include the above-described pixel circuit. In the OLED display device, there may be differences between threshold voltages of driving transistors in respective pixel circuits due to a preparation process, and due to influence of, for example, temperature variation, a drift phenomenon may occur to the threshold voltage of the driving transistor. Therefore, the difference in the threshold voltages of the respective driving transistors may cause poor display (e.g., uneven display), so the threshold voltage needs to be compensated. Meanwhile, when the driving transistor is in a turn-off state, presence of a leakage current may also cause poor display.

Therefore, other pixel circuits having a compensation function are also provided in the industry on the basis of the basic pixel circuit of 2T1C as described above. The compensation function may be implemented by voltage compensation, current compensation, or hybrid compensation. The pixel circuit having a compensation function may be of, for example, a 4T1C type or a 4T2C type, etc., and no details will be repeated here.

With respect to current pixel circuits, especially those applied to display screens (e.g., mobile phones, watches, etc.), due to presence of residual charges during operation process before writing data and before emitting light, these residual charges will affect performance of the circuit, further affecting accuracy of data writing and affecting a potential of an anode of a light emitting device during a light emitting phase. Especially after the frequency is changed, such an adverse effect is more obvious.

At least one embodiment of the present disclosure provides a pixel circuit and a method for driving the pixel circuit, a display panel, and a display device. By utilizing the method for driving the pixel circuit, effects of residual charges on accuracy of data writing and on the potential of the anode of the light emitting device in the light emitting phase may be reduced or eliminated, thereby optimizing the display effect.

Hereinafter, the embodiments of the present disclosure will be illustrated in detail with reference to the accompanying drawings. It should be noted that same reference signs in different drawings are be used to refer to same components that have already been described.

At least one embodiment of the present disclosure provides a method for driving a pixel circuit. The pixel circuit includes a driving circuit, a data writing circuit, a threshold compensating circuit, a storage circuit, a first light emission control circuit, and a first reset circuit. The driving circuit comprises a control terminal, a first terminal, and a second terminal, and is configured to control a drive current flowing through a light emitting element. The data writing circuit is connected with the first terminal of the driving circuit, and is configured to write a data signal into the first terminal of the driving circuit in response to a first scanning signal. The threshold compensating circuit is connected between the control terminal of the driving circuit and the second terminal of the driving circuit, and is configured to write a compensation signal based on the data signal into the control terminal of the driving circuit in response to a second scanning signal. The storage circuit is connected with the control terminal of the driving circuit and a first voltage line, and is configured to store the compensation signal and keep the compensation signal at the control terminal of the driving circuit. The first light emission control circuit is connected with the first voltage line and the first terminal of the driving circuit, and is configured to apply a first voltage supplied by the first voltage line to the first terminal of the driving circuit in response to a first light emission control signal. The first reset circuit is connected with the threshold compensating circuit, and is configured to apply a first reset voltage to the control terminal of the driving circuit in response to a first reset signal. The control terminal of the driving circuit is connected with the storage circuit at a first node, and the first light emission control circuit is connected with the first terminal of the driving circuit at a second node. The method comprises: before a data writing phase, the first reset circuit turning on in response to the first reset signal to apply the first reset voltage to the control terminal of the driving circuit, so as to reset the first node, and the first light emission control circuit turning on in response to the first light emission control signal to apply the first voltage to the first terminal of the driving circuit, so as to reset the second node; during the data writing phase, the data writing circuit turning on in response to the first scanning signal, so as to write the data signal into the first terminal of the driving circuit; and during a light emitting phase, the first light emission control circuit turning on in response to the first light emission control signal, and the light emitting element emitting light according to the drive current.

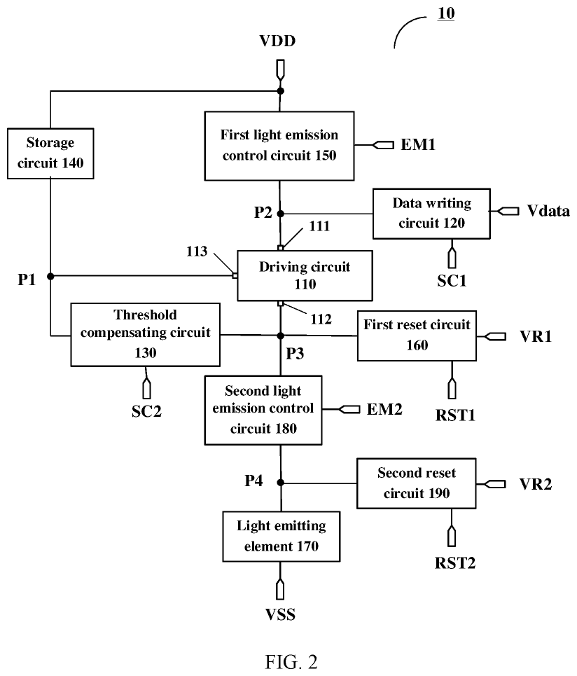

FIG. 2 is a schematic block diagram of a pixel circuit provided by some embodiments of the present disclosure. By using the method provided by the embodiments of the present disclosure, the pixel circuit illustrated in FIG. 2 can be driven.

As illustrated in FIG. 2, a pixel circuit 10 includes a driving circuit 110, a data writing circuit 120, a threshold compensating circuit 130, a storage circuit 140, a first light emission control circuit 150, and a first reset circuit 160.

For example, the driving circuit 110 includes a first terminal 111, a second terminal 112 and a control terminal 113. The driving circuit 110 is configured to control a drive current flowing through a light emitting element 170. For example, during the light emitting phase, the driving circuit 110 can supply a drive current to the light emitting element 170 to drive the light emitting element 170 to emit light according to a required “gray scale”. For example, the light emitting element 170 may be any type of applicable device and may include a plurality of structures, which may be selected and arranged according to actual needs, and will not be limited in the embodiments of the present disclosure. For example, the light emitting element 170 may be an OLED, a quantum dot light emitting diode (QLED), or a micro light emitting diode (Micro LED), etc., which may be determined according to actual needs.

The data writing circuit 120 is connected with the first terminal 111 of the driving circuit 110, and is configured to write a data signal into the first terminal 111 of the driving circuit 110 in response to a first scanning signal. For example, the data writing circuit 120 is connected with a first scanning line SC1 and a data line Vdata. The first scanning line SC1 is used for supplying the first scanning signal, and the data line Vdata is used for supplying the data signal. During the data writing phase, the data writing circuit 120 is turned on in response to the first scanning signal supplied by the first scanning line SC1, so as to write the data signal supplied by the data line Vdata into the first terminal 111 of the driving circuit 110. The data signal is further written into the control terminal 113 of the driving circuit 110 through the driving circuit 110 and the threshold compensating circuit 130, and is stored in the storage circuit 140, so as to generate a drive current that drives the light emitting element 170 to emit light according to the data signal during the light emitting phase.

The threshold compensating circuit 130 is connected between the control terminal 113 of the driving circuit 110 and the second terminal 112 of the driving circuit 110, and is configured to write a compensation signal based on the data signal into the control terminal 113 of the driving circuit 110 in response to a second scanning signal. For example, the threshold compensating circuit 130 may be directly connected with the control terminal 113 and the second terminal 112 of the driving circuit 110, that is, it is directly connected between the control terminal 113 of the driving circuit 110 and the second terminal 112 of the driving circuit 110. Of course, the threshold compensating circuit 130 may also be indirectly connected between the control terminal 113 and the second terminal 112 of the driving circuit 110, that is, other circuits (e.g., an anti-creeping circuit 230 described below) may also be arranged between the threshold compensating circuit 130 and the control terminal 113 of the driving circuit 110, and between the threshold compensating circuit 130 and the second terminal 112 of the driving circuit 110, which is not limited in the embodiments of the present disclosure.

For example, the threshold compensating circuit 130 is connected with a second scanning line SC2, and the second scanning line SC2 is used for supplying the second scanning signal. When the first scanning signal supplied by the first scanning line SC1 and the second scanning signal supplied by the second scanning line SC2 are both at an active level, the data writing circuit 120 and the threshold compensating circuit 130 are both turned on. At this time, the driving circuit 110 is also turned on, the data signal is transmitted to the threshold compensating circuit 130 through the data writing circuit 120 and the driving circuit 110, and the threshold compensating circuit 130 generates a compensation signal based on the data signal and writes the compensation signal into the control terminal 113 of the driving circuit 110. For example, during the data writing phase, the threshold compensating circuit 130 can electrically connect the control terminal 113 and the second terminal 112 of the driving circuit 110, so that information related to the threshold voltage of the driving circuit 110 is also correspondingly stored in the storage circuit 140. Therefore, during the light emitting phase, the stored voltage including the data signal and the threshold voltage can be used to control the driving circuit 110, so that the driving circuit 110 can be compensated.

The storage circuit 140 is connected with the control terminal 113 of the driving circuit 110 and a first voltage line VDD, and is configured to store the compensation signal and keep the compensation signal at the control terminal 113 of the driving circuit 110.

The first light emission control circuit 150 is connected with the first voltage line VDD and the first terminal 111 of the driving circuit 110, and is configured to apply a first voltage supplied by the first voltage line VDD to the first terminal 111 of the driving circuit 110 in response to a first light emission control signal. For example, the first light emission control circuit 150 is connected with a first light emission control line EM1, and the first light emission control line EM1 is used for supplying the first light emission control signal. The first light emission control circuit 150 can be turned on in response to the first light emission control signal, to electrically connect the first terminal 111 of the driving circuit 110 and the first voltage line VDD, so as to apply the first voltage supplied by the first voltage line VDD to the first terminal 111 of the driving circuit 110.

The first reset circuit 160 is connected with the threshold compensating circuit 130, and is configured to apply a first reset voltage to the control terminal 113 of the driving circuit 110 in response to a first reset signal. For example, the first reset circuit 160 is connected with a first reset line RST1 and a first reset voltage line VR1. The first reset line RST1 is used for supplying the first reset signal, and the first reset voltage line VR1 is used for supplying the first reset voltage. The first reset circuit 160 can be turned on in response to the first reset signal, so as to transmit the first reset voltage to the second terminal 112 of the driving circuit 110. The first reset voltage is further transmitted to the control terminal 113 of the driving circuit 110 through the threshold compensating circuit 130, so as to reset the control terminal 113 of the driving circuit 110.

An anode of the light emitting element 170 receives the drive current supplied by the driving circuit 110, a cathode of the light emitting element 170 is connected to a second voltage line VSS, and the second voltage line VSS is used for supplying a second voltage.

It should be noted that for the purpose of description, the first voltage line VDD in the respective embodiments of the present disclosure, for example, keeps inputting direct-current high-level signal, and the direct-current high-level is referred to as the first voltage; the second voltage line VSS, for example, keeps inputting direct-current low-level signal, and the direct-current low-level is referred to as the second voltage (which may be the ground voltage) and the second voltage is lower than the first voltage. The following respective embodiments are the same in this aspect, and no details will be repeated here.

For example, in some examples, the pixel circuit 10 further includes a second light emission control circuit 180 and a second reset circuit 190.

The second light emission control circuit 180 is connected with the second terminal 112 of the driving circuit 110 and the light emitting element 170, and is configured to apply a voltage of the second terminal 112 of the driving circuit 110 to the light emitting element 170 in response to a second light emission control signal. For example, the second light emission control circuit 180 is connected with a second light emission control line EM2, and second light emission control line EM2 is used for supplying the second light emission control signal. The second light emission control circuit 180 can be turned on in response to the second light emission control signal, to electrically connect the second terminal 112 of the driving circuit 110 and the light emitting element 170 (e.g., the anode of the light emitting element 170), so as to apply the voltage of the second terminal 112 of the driving circuit 110 to the light emitting element 170.

The second reset circuit 190 is connected with the second light emission control circuit 180 and the light emitting element 170, and is configured to apply a second reset voltage to the light emitting element 170 (e.g., the anode of the light emitting element 170) in response to a second reset signal. For example, the second reset circuit 190 is connected with a second reset line RST2 and a second reset voltage line VR2, the second reset line RST2 is used for supplying the second reset signal, and the second reset voltage line VR2 is used for supplying the second reset voltage. The second reset circuit 190 can be turned on in response to the second reset signal, to transmit the second reset voltage to a connection position between the second light emission control circuit 180 and the light emitting element 170, so as to reset the light emitting element 170.

For example, the control terminal 113 of the driving circuit 110 is connected with the storage circuit 140 at a first node P1; the first light emission control circuit 150 is connected with the first terminal 111 of the driving circuit 110 at a second node P2; the second light emission control circuit 180 is connected with the second terminal 112 of the driving circuit 110 at a third node P3; and the second reset circuit 190 is connected with the second light emission control circuit 180 and the light emitting element 170 at a fourth node P4. For example, a potential of the third node P3 after being reset by the first reset circuit 160 is greater than a potential of the fourth node P4 after being reset by the second reset circuit 190. This may achieve a better reset effect, and better reduce or eliminate effects of residual charges on the potential of the anode of the light emitting device during the light emitting phase.

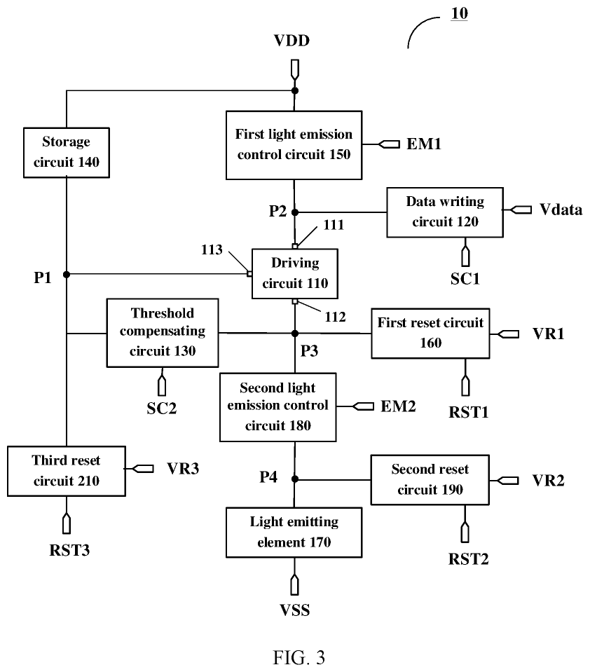

FIG. 3 is a schematic block diagram of another pixel circuit provided by some embodiments of the present disclosure. By using the driving method provided by the embodiments of the present disclosure, the pixel circuit illustrated in FIG. 3 can be driven.

As illustrated in FIG. 3, in some examples, the pixel circuit 10 may further include a third reset circuit 210. The third reset circuit 210 is connected with the threshold compensating circuit 130 and the control terminal 113 of the driving circuit 110. The third reset circuit 210 is configured to apply a third reset voltage to the control terminal 113 of the driving circuit 110 in response to a third reset signal. For example, the third reset circuit 210 is connected with a third reset line RST3 and a third reset voltage line VR3, the third reset line RST3 is used for supplying the third reset signal, and the third reset voltage line VR3 is used for supplying the third reset voltage. The third reset circuit 210 can be turned on in response to the third reset signal, to transmit the third reset voltage to the control terminal 113 of the driving circuit 110, so as to reset the control terminal 113 of the driving circuit 110. Other portions of the pixel circuit 10 are basically the same as the pixel circuit 10 illustrated in FIG. 2, and no details will be repeated here.

For example, in this example, a potential of the third node P3 after being reset by the first reset circuit 160 is greater than a potential of the fourth node P4 after being reset by the second reset circuit 190; a potential of the first node P1 after being reset by the third reset circuit 210 is less than the potential of the third node P3 after being reset by the first reset circuit 160; and the potential of the first node P1 after being reset by the third reset circuit 210 is less than or equal to the potential of the fourth node P4 after being reset by the second reset circuit 190. This can achieve a better reset effect, and better reduce or eliminate effects of residual charges on accuracy of data writing and on the potential of the anode of the light emitting device during the light emitting phase.

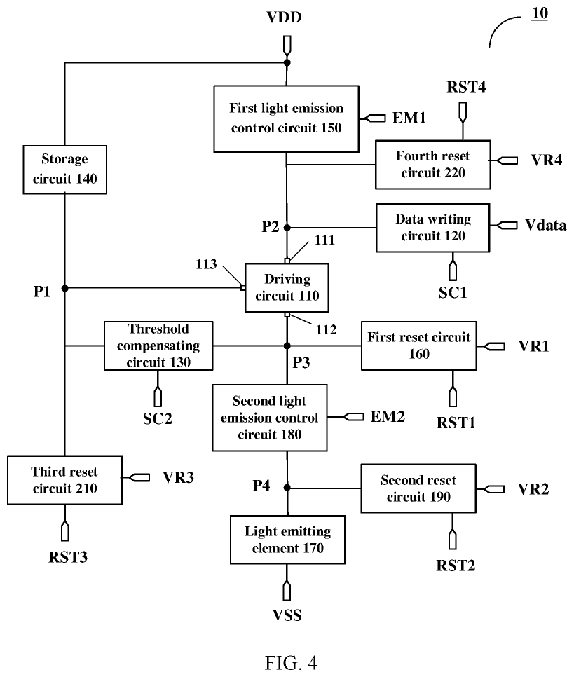

FIG. 4 is a schematic block diagram of another pixel circuit provided by some embodiments of the present disclosure. By using the driving method provided by the embodiments of the present disclosure, the pixel circuit illustrated in FIG. 4 can be driven.

As illustrated in FIG. 4, in some examples, the pixel circuit 10 may further include a fourth reset circuit 220. The fourth reset circuit 220 is connected with the first terminal 111 of the driving circuit 110, and the fourth reset circuit 220 is configured to apply a fourth reset voltage to the first terminal 111 of the driving circuit 110 in response to a fourth reset signal. For example, the fourth reset circuit 220 is connected with a fourth reset line RST4 and a fourth reset voltage line VR4, the fourth reset line RST4 is used for supplying the fourth reset signal, and the fourth reset voltage line VR4 is used for supplying the fourth reset voltage. The fourth reset circuit 220 can be turned on in response to the fourth reset signal, to transmit the fourth reset voltage to the first terminal 111 of the driving circuit 110, so as to reset the first terminal 111 of the driving circuit 110. Other portions of this pixel circuit 10 are basically the same as the pixel circuit 10 illustrated in FIG. 3, and no details will be repeated here.

For example, in this example, a potential of the third node P3 after being reset by the first reset circuit 160 is greater than a potential of the fourth node P4 after being reset by the second reset circuit 190; a potential of the first node P1 after being reset by the third reset circuit 210 is less than the potential of the third node P3 after being reset by the first reset circuit 160; the potential of the first node P1 after being reset by the third reset circuit 210 is less than or equal to the potential of the fourth node P4 after being reset by the second reset circuit 190; a potential of the second node P2 after being reset by the fourth reset circuit 220 is greater than the potential of the first node P1 after being reset by the third reset circuit 210; the potential of the second node P2 after being reset by the fourth reset circuit 220 is greater than the potential of the third node P3 after being reset by the first reset circuit 160; and the potential of the second node P2 after being reset by the fourth reset circuit 220 is greater than the potential of the fourth node P4 after being reset by the second reset circuit 190. This can achieve a better reset effect, and better reduce or eliminate effect of residual charges on accuracy of data writing and on the potential of the anode of the light emitting device in the light emitting phase.

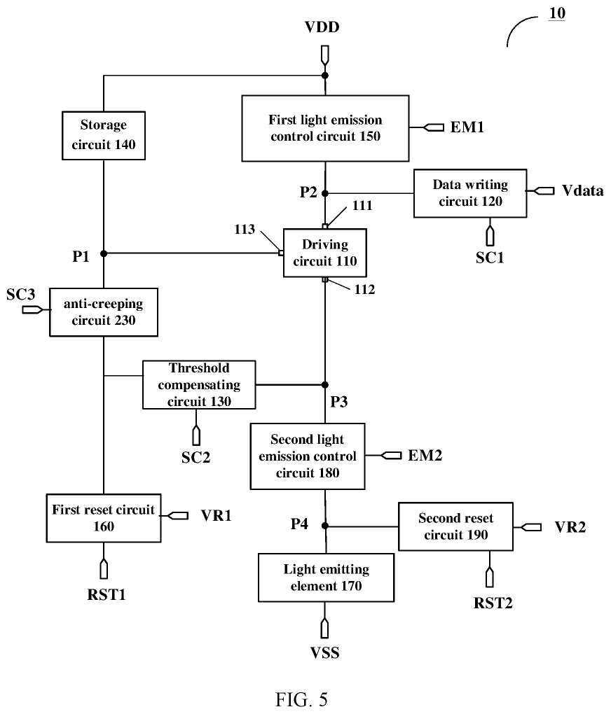

FIG. 5 is a schematic block diagram of another pixel circuit provided by some embodiments of the present disclosure. By using the driving method provided by the embodiments of the present disclosure, the pixel circuit illustrated in FIG. 5 can be driven.

As illustrated in FIG. 5, in some examples, the pixel circuit 10 may further include an anti-creeping circuit 230. The anti-creeping circuit 230 is connected with the control terminal 113 of the driving circuit 110, the threshold compensating circuit 130, and the storage circuit 140. The anti-creeping circuit 230 is configured to suppress electric leakage of the control terminal 113 of the driving circuit 110. The anti-creeping circuit 230 is also connected with a third scanning line SC3; and the third scanning line SC3 is used for supplying a third scanning signal. The anti-creeping circuit 230 can be turned on in response to the third scanning signal, so as to facilitate transmitting the required electrical signal to the control terminal 113 of the driving circuit 110. In this example, the first reset circuit 160 is connected with the threshold compensating circuit 130 and the anti-creeping circuit 230, and can apply the first reset voltage to the first node P1 through the turned-on anti-creeping circuit 230, or can also apply the first reset voltage to the third node P3 through the turned-on threshold compensating circuit 130. Other portions of this pixel circuit 10 are basically the same as the pixel circuit 10 illustrated in FIG. 2, and no details will be repeated here.

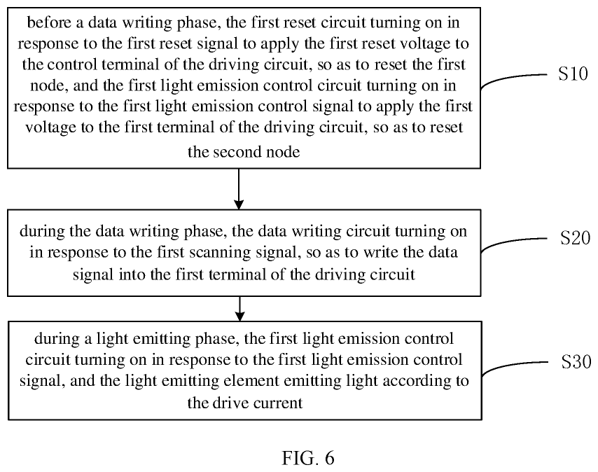

FIG. 6 is a schematic flow chart of a method for driving a pixel circuit provided by some embodiments of the present disclosure. The method, for example, can be used in the pixel circuit 10 illustrated in FIG. 2, FIG. 3, FIG. 4, and FIG. 5. As illustrated in FIG. 6, the driving method provided by the embodiments of the present disclosure may include operations below.

Step S10: before a data writing phase, the first reset circuit turning on in response to the first reset signal to apply the first reset voltage to the control terminal of the driving circuit, so as to reset the first node, and the first light emission control circuit turning on in response to the first light emission control signal to apply the first voltage to the first terminal of the driving circuit, so as to reset the second node,

Step S20: during the data writing phase, the data writing circuit turning on in response to the first scanning signal, so as to write the data signal into the first terminal of the driving circuit.

Step S30: during the light emitting phase, the first light emission control circuit turning on in response to the first light emission control signal, and the light emitting element emitting light according to the drive current.

For example, with respect to the pixel circuit 10 illustrated in FIG. 2, FIG. 3, and FIG. 4, the reset operation on the first node in step S10 may include: the first reset circuit 160 turning on in response to the first reset signal, and the threshold compensating circuit 130 turning on in response to the second scanning signal, to apply the first reset voltage to the control terminal 113 of the driving circuit 110 through a path formed by the first reset circuit 160 and the threshold compensating circuit 130, so as to reset the first node P1. For example, before the data writing phase, the first reset circuit 160 is turned on in response to the first reset signal, and at this time, the threshold compensating circuit 130 is turned on in response to the second scanning signal, to apply the first reset voltage to the control terminal 113 of the driving circuit 110, that is, apply the first reset voltage to the first node P1, so as to reset the first node P1. Moreover, the first light emission control circuit 150 is turned on in response to the first light emission control signal, to apply the first voltage to the first terminal 111 of the driving circuit 110, that is, apply the first voltage to the second node P2, so as to reset the second node P2.

For example, in step S10, with respect to the pixel circuit 10 illustrated in FIG. 5, before the data writing phase, the first reset circuit 160 is turned on in response to the first reset signal, and at this time, the anti-creeping circuit 230 is turned on in response to the third scanning signal, to apply the first reset voltage to the control terminal 113 of the driving circuit 110, that is, apply the first reset voltage to the first node P1, so as to reset the first node P1. Moreover, the first light emission control circuit 150 is turned on in response to the first light emission control signal, to apply the first voltage to the first terminal 111 of the driving circuit 110, that is, apply the first voltage to the second node P2, so as to reset the second node P2.

For example, in step S20, during the data writing phase, the data writing circuit 120 is turned on in response to the first scanning signal, to write the data signal into the first terminal 111 of the driving circuit 110, that is, write the data signal into the second node P2. At this time, the driving circuit 110 and the threshold compensating circuit 130 are also turned on. With respect to the pixel circuit 10 illustrated in FIG. 5, the anti-creeping circuit 230 is also turned on. Thus, the data signal may be written from the second node P2 into the control terminal 113 of the driving circuit 110, that is, written into the first node P1, and thus stored in the storage circuit 140. In this process, information related to the threshold voltage of the driving circuit 110 is also correspondingly stored in the storage circuit 140. Therefore, during the light emitting phase, the stored voltage including the data signal and the threshold voltage can be used to control the driving circuit 110, so that the driving circuit 110 can be compensated.

For example, in step S30, during the light emitting phase, the first light emission control circuit 150 is turned on in response to the first light emission control signal, and the light emitting element 170 emits light according to the drive current. At this time, the second light emission control circuit 180 is also turned on, so as to form a current path between the first voltage line VDD and the second voltage line VSS. The driving circuit 110 controls a magnitude of the drive current, so that the light emitting element 170 emits light according to the required “gray scale”.

For example, the driving method provided by the embodiments of the present disclosure may further include operations below:
before the data writing phase, the first reset circuit applying the first reset voltage to the second terminal of the driving circuit while the first reset circuit resets the first node, so as to reset the third node; and/or
before the data writing phase, the second reset circuit turning on in response to the second reset signal, to apply the second reset voltage to the light emitting element, so as to reset the fourth node.

For example, with respect to the pixel circuit 10 illustrated in FIG. 2, FIG. 3, and FIG. 4, before the data writing phase, while using the first reset circuit 160 to reset the first node P1, the first reset voltage is firstly written into the second terminal 112 of the driving circuit 110 (i.e., the third node P3), so that the third node P3 can be reset.

For example, with respect to the pixel circuit 10 illustrated in FIG. 5, before the data writing phase, while using the first reset circuit 160 to reset the first node P1, the threshold compensating circuit 130 can be turned on, so that the first reset voltage transmitted by the first reset circuit 160 can be transmitted to the third node P3 through the threshold compensating circuit 130, so as to reset the third node P3.

For example, before the data writing phase, the second reset circuit 190 is turned on in response to the second reset signal, to apply the second reset voltage to the light emitting element 170 (e.g., the anode of the light emitting element 170), so as to reset the fourth node P4.

For example, in some examples, before the data writing phase, the first node P1 and the second node P2 are reset simultaneously, or the first node P1 and the second node P2 are reset separately in different time periods. That is, the first node P1 and the second node P2 may be reset simultaneously, or the first node P1 and the second node P2 may be reset in a sequential order: firstly resetting the first node P1 and then resetting the second node P2, or firstly resetting the second node P2 and then resetting the first node P1.

For example, in some examples, before the data writing phase, in the case of resetting both the third node P3 and the fourth node P4, the third node P3 and the fourth node P4 are reset simultaneously or reset separately in different time periods. That is, the third node P3 and the fourth node P4 may be reset simultaneously, or the third node P3 and the fourth node P4 may be reset in a sequential order: firstly resetting the third node P3 and then resetting the fourth node P4, or firstly resetting the fourth node P4 and then resetting the third node P3.

For example, in some examples, before the data writing phase, a reset period of at least one of the third node P3 or the fourth node P4 coincides with a reset period of at least one of the first node P1 or the second node P2. That is, at least one of the third node P3 or the fourth node P4 is reset simultaneously with at least one of the first node P1 or the second node P2.

For example, in some examples, before the data writing phase, none of the reset period of the first node P1, the reset period of the second node P2, the reset period of the third node P3, and the reset period of the fourth node P4 coincides. That is, none of the nodes has a reset period coincide with a reset period of another node; and there is only one node reset in each reset period. It should be noted that the reset period refers to a period of time during which a node is reset. The reset period may be a continuous period of time or a brief point of time, which may be determined according to the length of time required for the reset operation, and will not be limited in the embodiments of the present disclosure.

For example, the driving method provided by the embodiments of the present disclosure may further include operations below:
after the data writing phase and before the light emitting phase, the first light emission control circuit turning on in response to the first light emission control signal, to apply the first voltage to the first terminal of the driving circuit, so as to reset the second node; and/or
after the data writing phase and before the light emitting phase, the first reset circuit turning on in response to the first reset signal, to apply the first reset voltage to the second terminal of the driving circuit, so as to reset the third node; and/or
after the data writing phase and before the light emitting phase, the second reset circuit turning on in response to the second reset signal, to apply the second reset voltage to the light emitting element, so as to reset the fourth node.

For example, with respect to the pixel circuit 10 illustrated in FIG. 2, FIG. 3, FIG. 4, and FIG. 5, after the data writing phase and before the light emitting phase, the first light emission control circuit 150 is turned on in response to the first light emission control signal, to apply the first voltage to the first terminal 111 of the driving circuit 110, that is, apply the first voltage to the second node P2, so as to reset the second node P2.

For example, with respect to the pixel circuit 10 illustrated in FIG. 2, FIG. 3, and FIG. 4, after the data writing phase and before the light emitting phase, the first reset circuit 160 is turned on in response to the first reset signal, to apply the first reset voltage to the second terminal 112 of the driving circuit 110, that is, apply the first reset voltage to the third node P3, so as to reset the third node P3.

For example, with respect to the pixel circuit 10 illustrated in FIG. 5, after the data writing phase and before the light emitting phase, while turning on the first reset circuit 160, the threshold compensating circuit 130 is also turned on, so that the first reset voltage can be applied to the third node P3 through the threshold compensating circuit 130, so as to reset the third node P3.

For example, after the data writing phase and before the light emitting phase, the second reset circuit 190 is turned on in response to the second reset signal, to apply the second reset voltage to the light emitting element 170 (e.g., the anode of the light emitting element 170), that is, apply the second reset voltage to the fourth node P4, so as to reset the fourth node P4.

For example, in some examples, after the data writing phase and before the light emitting phase, at least two nodes among the second node P2, the third node P3, and the fourth node P4 are reset simultaneously, or at least two nodes among the second node P2, the third node P3, and the fourth node P4 are reset separately in different time periods. That is, the second node P2, the third node P3, and the fourth node P4 may be reset separately in three different reset periods; or any two nodes among the second node P2, the third node P3, and the fourth node P4 may be reset simultaneously, and the remaining one node is reset in a different time period; or the second node P2, the third node P3, and the fourth node P4 may be reset simultaneously in a same time period. This can be determined according to actual needs, and will not be limited in the embodiments of the present disclosure.

In the driving method provided by the embodiments of the present disclosure, before the data writing phase, any one or more nodes among the first node P1, the second node P2, the third node P3, and the fourth node P4 may be reset. With respect to nodes that need to be reset, these nodes may be reset simultaneously, or the respective nodes may also have reset periods staggered from each other. Therefore, before writing data, one or more of the anode of OLED and/or the source electrode, the drain electrode, and the gate electrode of the driving transistor may be initialized or reset. By resetting the nodes on the data writing path, adverse effects caused by residual charges can be reduced or eliminated, so as to optimize the display effect.

In the driving method provided by the embodiments of the present disclosure, after the data writing phase and before the light emitting phase, any one or more nodes among the second node P2, the third node P3, and the fourth node P4 may be reset. With respect to nodes that need to be reset, these nodes may be reset simultaneously, or the respective nodes may have reset periods staggered from each other. Therefore, after writing data and before emitting light, one or more of the anode of OLED and/or the source electrode and the drain electrode of the driving transistor may be initialized or reset. By resetting the nodes on the light emitting path, adverse effects caused by residual charges can be reduced or eliminated, so as to optimize the display effect.

In the driving method provided by the embodiments of the present disclosure, the nodes that need to be reset before the data writing phase and the nodes that need to be reset after the data writing phase and before the light emitting phase may be the same or different; and the reset operation before the data writing phase and the reset operation after the data writing phase and before the light emitting phase may be the same or different, which may be determined according to actual needs, and will not be limited in the embodiments of the present disclosure.

Hereinafter, the driving method provided by the embodiments of the present disclosure is briefly illustrated in conjunction with specific circuit structures.

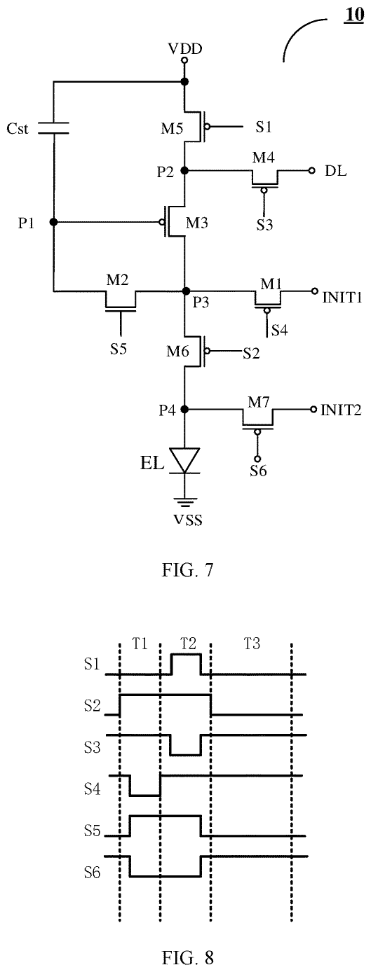

FIG. 7 is a schematic diagram of a circuit structure of the pixel circuit illustrated in FIG. 2. As illustrated in FIG. 7, the pixel circuit 10 includes: transistors M1 to M7 and a storage capacitor Cst. For example, the transistor M3 is used as the driving transistor, while other transistors are used as switch transistors. The light emitting element 170 may be implemented as a light emitting element EL, the light emitting element EL, for example, may be an OLED, and the embodiments of the present disclosure include but are not limited thereto. Hereinafter, the respective embodiments are illustrated all by taking the OLED as an example, and no details will be repeated here. The OLED may be of various types, for example, a top emission structure, a bottom emission structure, etc., and may emit red light, green light, blue light, or white light, etc., which will not be limited in the embodiments of the present disclosure.

For example, as illustrated in FIG. 7, in more detail, the driving circuit 110 may be implemented as a driving transistor, i.e., the transistor M3. A gate electrode of the driving transistor (the transistor M3) serves as the control terminal 113 of the driving circuit 110; a first electrode of the driving transistor (the transistor M3) serves as the first terminal 111 of the driving circuit 110; and a second electrode of the driving transistor (the transistor M3) serves as the second terminal 112 of the driving circuit 110.

The data writing circuit 120 may be implemented as a data writing transistor, i.e., the transistor M4. A gate electrode of the data writing transistor (the transistor M4) is connected with the first scanning line (the scanning line S3) to receive the first scanning signal; a first electrode of the data writing transistor (the transistor M4) is connected with the data line (the data line DL) to receive the data signal; and a second electrode of the data writing transistor (the transistor M4) is connected with the first electrode of the driving transistor (the transistor M3) at the second node P2.

The threshold compensating circuit 130 may be implemented as a threshold compensating transistor, i.e., the transistor M2. A gate electrode of the threshold compensating transistor (the transistor M2) is connected with the second scanning line (the scanning line S5) to receive the second scanning signal; a first electrode of the threshold compensating transistor (the transistor M2) is connected with the second electrode of the driving transistor (the transistor M3) at the third node P3; and a second electrode of the threshold compensating transistor (the transistor M2) is connected with the gate electrode of the driving transistor (the transistor M3) at the first node P1.

The storage circuit 140 may be implemented as a storage capacitor Cst. A first electrode of the storage capacitor Cst is connected with the first voltage line VDD, and a second electrode of the storage capacitor Cst is connected with the gate electrode of the driving transistor (the transistor M3) at the first node P1.

The first light emission control circuit 150 may be implemented as a first light emission control transistor, i.e., the transistor M5. A gate electrode of the first light emission control transistor (the transistor M5) is connected with the first light emission control line (the scanning line S1) to receive the first light emission control signal; a first electrode of the first light emission control transistor (the transistor M5) is connected with the first voltage line VDD; and a second electrode of the first light emission control transistor (the transistor M5) is connected with the first terminal of the driving circuit, that is, connected with the first electrode of the driving transistor (the transistor M3) at the second node P2.

The first reset circuit 160 may be implemented as a first reset transistor, i.e., the transistor M1. A gate electrode of the first reset transistor (the transistor M1) is connected with the first reset line (the scanning line S4) to receive the first reset signal; a first electrode of the first reset transistor (the transistor M1) is connected with the first reset voltage line (the voltage line INIT1) to receive the first reset voltage; and a second electrode of the first reset transistor (the transistor M1) is connected with the second electrode of the driving transistor (the transistor M3) at the third node P3.

The second light emission control circuit 180 may be implemented as a second light emission control transistor, i.e., the transistor M6. A gate electrode of the second light emission control transistor (the transistor M6) is connected with the second light emission control line (the scanning line S2) to receive the second light emission control signal; a first electrode of the second light emission control transistor (the transistor M6) is connected with the second terminal of the driving circuit, that is, connected with the second electrode of the driving transistor (the transistor M3) at the third node P3; and a second electrode of the second light emission control transistor (the transistor M6) is connected with the anode of the light emitting element EL at the fourth node P4.

The second reset circuit 190 may be implemented as a second reset transistor, i.e., the transistor M7. A gate electrode of the second reset transistor (the transistor M7) is connected with the second reset line (the scanning line S6) to receive the second reset signal; a first electrode of the second reset transistor (the transistor M7) is connected with the second reset voltage line (the voltage line INIT2) to receive the second reset voltage; and a second electrode of the second reset transistor (the transistor M7) is connected with the second electrode of the second light emission control transistor (the transistor M6) and the light emitting element EL at the fourth node P4.

For example, the driving transistor (the transistor M3), the data writing transistor (the transistor M4), the first light emission control transistor (the transistor M5), and the first reset transistor (the transistor M1) are transistors of a first type; the threshold compensating transistor (the transistor M2) is a transistor of a second type; and the first type is different from the second type. For example, in some examples, the transistor of the first type includes a P-type thin film transistor; the transistor of the second type includes an N-type thin film transistor. That is, the driving transistor (the transistor M3), the data writing transistor (the transistor M4), the first light emission control transistor (the transistor M5), the first reset transistor (the transistor M1) are P-type thin film transistors; and the threshold compensating transistor (the transistor M2) is an N-type transistor. Of course, the embodiments of the present disclosure are not limited thereto, and the types of certain transistors adopted in the pixel circuit 10 may be changed according to actual needs, for example, the P-type thin film transistors can be changed to N-type thin film transistors, or the N-type thin film transistors can be changed to P-type thin film transistors.

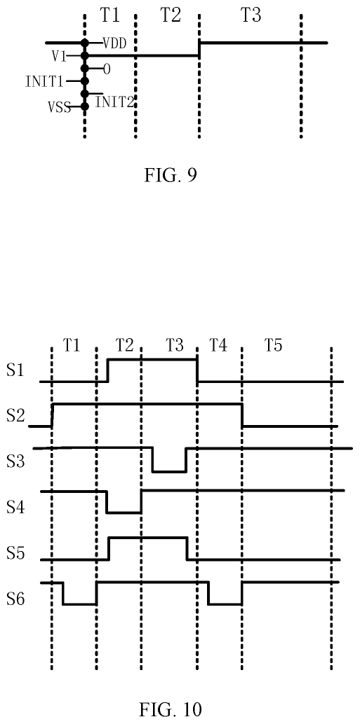

FIG. 8 is a timing diagram for the pixel circuit illustrated in FIG. 7 provided by some embodiments of the present disclosure. As illustrated in FIG. 8, in some examples, in a first phase T1, the gate electrode of the transistor M5 is connected to the scanning line S1, S1 is at a low potential, the transistor M5 is turned on, a high potential of the first voltage line VDD is written into the first electrode of the transistor M3, that is, written into the second node P2, a potential of the second node P2 is V1, and the potential of V1 may be VDD, or may also be greater than 0 and less than VDD, as illustrated in FIG. 9. If the potential of V1 is equal to VDD, then the potential supplied by the first voltage line VDD is constant; if the potential of V1 is greater than 0 and less than VDD, then the potential supplied by the first voltage line VDD is variable. The gate electrode of the transistor M1 is connected to the scanning line S4, S4 is at a low potential, the transistor M1 is turned on, the gate electrode of the transistor M2 is connected to the scanning line S5, S5 is at a high potential, the transistor M2 is turned on, and the low potential of the voltage line INIT1 is written into the second electrode of the transistor M3 (i.e., the third node P3) and the gate electrode of the transistor M3 (i.e., the first node P1). The gate electrode of the transistor M7 is connected to the scanning line S6, S6 is at a low potential, the transistor M7 is turned on, and the low potential of the voltage line INIT2 is written into the anode of the light emitting element EL (i.e., the fourth node P4). Therefore, in the first phase T1, the anode of the light emitting element EL as well as the first electrode, the second electrode, and the gate electrode of the transistor M3 are reset, thereby eliminating residual charges of the previous frame display, which is favorable for accurate data writing in the second phase T2.

In the second phase T2, S3, and S5 are respectively at a low level and a high level, the transistor M4 and the transistor M2 are turned on, and the data signal is written into the gate electrode of the transistor M3 sequentially through the transistor M4, the transistor M3, and the transistor M2; at this time, the potential of the first node P1 is Vdata+|Vth|. Vdata is the data signal, and Vth is the threshold voltage of the transistor M3. In this phase, in order to ensure that the fourth node P4 may keep a stable low potential before light emitting, thus, in the second phase T2, the transistor M7 is still turned on, and the low potential of the voltage line INIT2 is written into the fourth node P4. That is, in both the first phase T1 and the second phase T2, the fourth node P4 is reset.

In the third phase T3, the potentials of S1 and S2 are at a low level, the transistor M5 and the transistor M6 are turned on, and the light emitting element EL emits light. The current flowing through the transistor M3 is: I=1/2μ*W/L*Cox (Vgs−Vth) 2=1/2μ*W/L*Cox (VDD−Vdata)2, where W/L is a breadth length ratio of the transistor M3, Cox is a dielectric constant of a channel insulation layer of the transistor M3, and μ is channel carrier mobility of the transistor M3. Through simulation, a better simulation effect is achieved, with simulation conditions of VDD being 4.6 V, VSS being −3 V, Vinit (i.e., INIT1 and INIT2) being −3 V, Vdata being 3 V, and Vth being −2 V. Here, the better simulation effect refers to high accuracy in writing data, and the potential of the anode of the light emitting device in the light emitting phase being almost unaffected by residual charges.

As illustrated in FIG. 9, in the third phase T3, that is, in the light emitting phase, the potential of the first voltage line VDD is VDD; in the non-light-emitting phase, including the first phase T1 for resetting and the second phase T2 for data writing, in order to save power consumption, the potential of the first voltage line may be reduced to V1. The potential of the second node P2 may be V1, that is, greater than 0 as well as less than or equal to VDD, so that the reset effect can be achieved.

In this example, S2 and S5 may be signals output by a same gate driving circuit (e.g., GOA); S3 and S4 may be signals supplied by a same type of GOA, for example, S3 is a signal supplied by a certain stage of shift register unit in the GOA, and S4 is a signal supplied by a previous stage of shift register unit in the GOA. Therefore, for one row of pixel circuits, at least 4 GOAs are required, or, one stage of shift register unit of the GOA needs to output 4 shift signals (if the GOA adopted is capable of outputting a plurality of signals, for example, one GOA may output signals with two different pulse widths or signals with two different potentials).

FIG. 10 is another timing diagram for the pixel circuit illustrated in FIG. 7 provided by some embodiments of the present disclosure. As compared with the example illustrated in FIG. 8, this example illustrated in FIG. 10 has a time period added between the reset phase and the data writing phase in FIG. 8, for resetting the drain electrode and the gate electrode of the transistor M3 (i.e., the third node P3 and the first node P1). Of course, in order to shorten the time for reset, in other examples, this phase may also be incorporated into the T1 phase.

In the example illustrated in FIG. 10, after data writing and before light emitting, the source electrode of the transistor M3 (i.e., the second node P2) and the drain electrode of the transistor M7 (i.e., the anode of the light emitting element EL) are reset again, that is, a T4 phase is added. Resetting the second node P2 again is to eliminate residual charges at the second node P2 after data writing, and to further eliminate effect on the current flowing into the driving transistor (the transistor M3) in the light emitting phase. Resetting the fourth node P4 again is to eliminate residual charges that may be generated by a leakage current possibly flowing through the transistor M6 in the data writing phase at the fourth node P4. The low potential of S6 controls the transistor M7 being turned on; and in order to ensure the potential of the fourth node P4 to be capable of keeping at the potential of INIT2 for a long time in the non-light-emitting phase, S6 may be set to keep at a low potential for all the 4 time periods of T1 to T4. Through simulation, a better simulation effect is achieved with simulation conditions of VDD being 4.6 V, VSS being −3 V, Vinit (i.e., INIT1 and INIT2) being −3 V, and Vdata being 3 V.

In this example, S3 and S4 may be signals supplied by a same type of GOA, for example, S3 is a signal supplied by a certain stage of shift register unit in the GOA, and S4 is a signal supplied by a previous stage of shift register unit in the GOA. Therefore, for one row of pixel circuits, at least 4 GOAs are required, or, one stage of shift register unit of the GOA needs to output 4 shift signals (if the GOA adopted is capable of outputting a plurality of signals, for example, one GOA may output signals with two different pulse widths or signals with two different potentials).

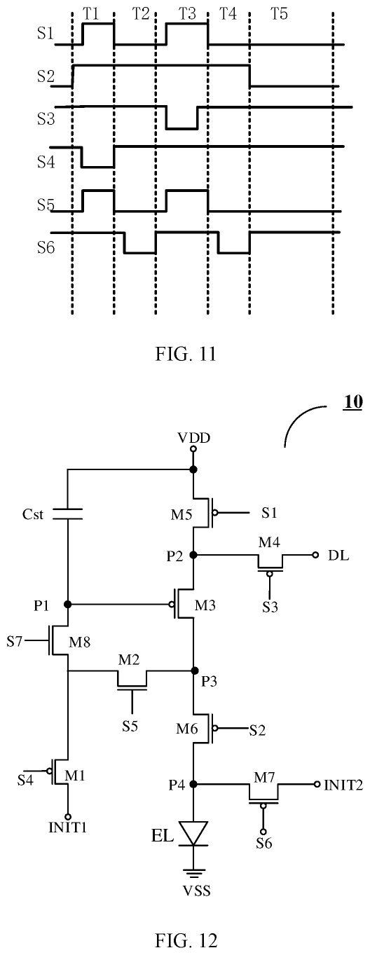

FIG. 11 is another timing diagram for the pixel circuit illustrated in FIG. 7 provided by some embodiments of the present disclosure. The example illustrated in FIG. 11 is the same as the example illustrated in FIG. 10 in that: in the previous phase T2 and the next phase T4 of the data writing phase T3, reset operations are performed on both the second node P2 and the fourth node P4, to ensure that data can be accurately written, and residual charges on the light emitting path can be eliminated before light emitting. In this example, the reset operation on the first node P1 and the third node P3 is carried out in the first phase T1.

In this example, S1 and S5 may be signals output by a same GOA; S3 and S4 may be signals supplied by a same type of GOA, for example, S3 is a signal supplied by a certain stage of shift register unit in the GOA, and S4 is a signal supplied by the previous two stage of shift register unit in the GOA. Therefore, for one row of pixel circuits, at least 4 GOAs are required, or, one stage of shift register unit of the GOA needs to output 4 shift signals.

FIG. 12 is a schematic diagram of a circuit structure of the pixel circuit illustrated in FIG. 5. As illustrated in FIG. 12, the pixel circuit 10 includes: transistors M1 to M8 and a storage capacitor Cst. For example, the transistor M3 is used as the driving transistor, while other transistors are used as switch transistors. The light emitting element 170 may be implemented as a light emitting element EL; the light emitting element EL, for example, may be an OLED; and the embodiments of the present disclosure include but are not limited thereto. Hereinafter, the respective embodiments are illustrated all by taking the OLED as an example, and no details will be repeated here. The OLED may be of various types, for example, a top emission structure, a bottom emission structure, etc., and may emit red light, green light, blue light, or white light, etc., which will not be limited in the embodiments of the present disclosure.

For example, as illustrated in FIG. 12, in more detail, the driving circuit 110 may be implemented as a driving transistor, that is, the transistor M3; the data writing circuit 120 may be implemented as a data writing transistor, that is, the transistor M4; the threshold compensating circuit 130 may be implemented as a threshold compensating transistor, that is, the transistor M2; the storage circuit 140 may be implemented as a storage capacitor Cst; the first light emission control circuit 150 may be implemented as a first light emission control transistor, that is, the transistor M5; the second light emission control circuit 180 may be implemented as a second light emission control transistor, that is, the transistor M6; the second reset circuit 190 may be implemented as a second reset transistor, that is, the transistor M7. Connection modes of these transistors and the storage capacitor are similar to that of the circuit structure illustrated in FIG. 7, and no details will be repeated here.

This example differs from the circuit structure illustrated in FIG. 7 in that: the first reset circuit 160 has a different connection mode, and an anti-creeping circuit 230 is further provided. For example, the first reset circuit 160 may be implemented as a first reset transistor, that is, the transistor M1. The gate electrode of the first reset transistor (the transistor M1) is connected with the first reset line (the scanning line S4); the first electrode of the first reset transistor (the transistor M1) is connected with the first reset voltage line (the voltage line INIT1); and the second electrode of the first reset transistor (the transistor M1) is connected with the second electrode of the transistor M2. The anti-creeping circuit 230 may be implemented as an anti-creeping transistor, that is, the transistor M8. The gate electrode of the anti-creeping transistor (the transistor M8) is connected with the third scanning line (the scanning line S7); the first electrode of the anti-creeping transistor (the transistor M8) is connected with the second electrode of the transistor M2; and the second electrode of the anti-creeping transistor (the transistor M8) is connected with the gate electrode of the transistor M3 at the first node P1. For example, the anti-creeping transistor is a transistor of the second-type, for example, an N-type thin film transistor.

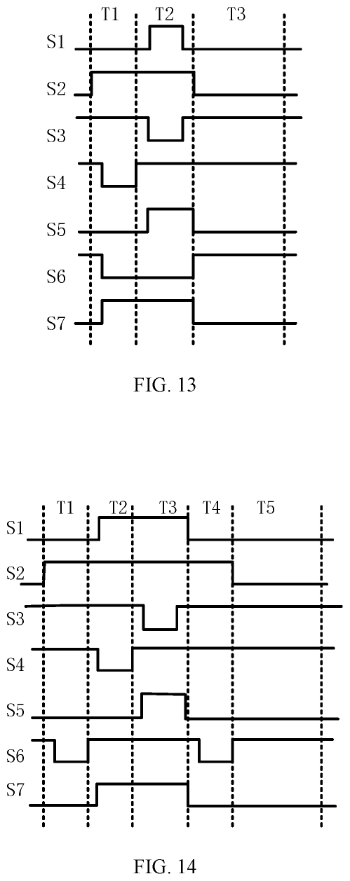

FIG. 13 is a timing diagram for the pixel circuit illustrated in FIG. 12 provided by some embodiments of the present disclosure. As illustrated in FIG. 13, in some examples, as compared with the circuit structure illustrated in FIG. 7 adopted in the previous examples, the pixel circuit 10 adopted in this example includes two N-type thin film transistors (the transistor M8 and the transistor M2), and thus can better prevent electric leakage at the first node P1 that is prone to leakage. Moreover, the two N-type thin film transistors M2 and M8 can enhance flexibility of operation, for example, when only the first node P1 needs to be reset, it is merely necessary to turn on the transistor M8.

As illustrated in FIG. 13, in the first phase T1, the transistor M8 controlled by S7 is turned on; the transistor M1 controlled by S4 is turned on; and the first node P1 writes the reset voltage of INIT1 to reset the gate electrode of the transistor M3, that is, to reset the first node P1. The transistor M5 controlled by S1 is turned on; the transistor M7 controlled by S6 is turned on; the high potential of VDD is written into the second node P2, so as to reset the second node P2; and the potential of INIT2 is written into the anode of the light emitting element EL, so as to reset the fourth node P4.

In the second phase T2, the data write operation is performed. The transistor M4 controlled by S3 is turned on; the transistor M2 controlled by S5 is turned on; the data signal is written into the gate electrode of the transistor M3 (i.e., the first node P1); and at this time, the potential of the first node P1 is Vdata+|Vth|. Meanwhile, the transistor M7 controlled by S6 still keeps turned-on state, causing the potential of the fourth node P4 to be INIT2.

In the third phase T3, the potentials of S1 and S2 are at a low level, and the transistor M5 and the transistor M6 are turned on, so the light emitting element EL emits light.

FIG. 14 is another timing diagram for the pixel circuit illustrated in FIG. 12 provided by some embodiments of the present disclosure. The example illustrated in FIG. 14 differs from the example illustrated in FIG. 13 in that: the reset operation before writing data is carried out in two phases, that is, the second node P2 and the fourth node P4 are reset in the first phase T1, and the first node P1 is reset in the second phase T2. In order to shorten the time, in other examples, the T1 phase and the T2 phase in this example may also be incorporated into one phase. After writing data, the second node P2 and the fourth node P4 are reset again to eliminate residual charges on the light emitting path, and then the light emitting phase is entered.

In the example, S7 and S1 may be signals output by a same GOA; S3 and S4 may be signals supplied by a same type of GOA, for example, S3 is a signal supplied by a certain stage of shift register unit in the GOA, and S4 is a signal supplied by a previous stage of shift register unit in the GOA. Therefore, for one row of pixel circuits, at least 5 GOAs are required, or, one stage of shift register unit of the GOA needs to output 5 shift signals.

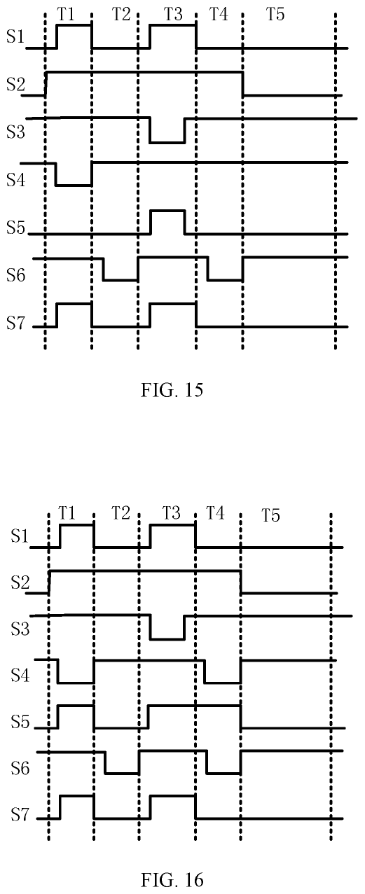

FIG. 15 is another timing diagram for the pixel circuit illustrated in FIG. 12 provided by some embodiments of the present disclosure. As illustrated in FIG. 15, in this example, reset operations are performed on both the second node P2 and the fourth node P4 in both the previous phase T2 and the next phase T4 of the data writing phase (the third phase T3). The reset operation on the first node P1 is carried out in the first phase T1. The above contents may be referred to for the turn-on situations of the respective transistors during the reset operation, and no details will be repeated here.

FIG. 16 is another timing diagram for the pixel circuit illustrated in FIG. 12 provided by some embodiments of the present disclosure. As illustrated in FIG. 16, in this example, reset operations are performed in the two phases before writing data. Specifically, the first node P1 and the third node P3 are reset in the first phase T1, and the second node P2 and the fourth node P4 are reset in the second phase T2. After writing data, the second node P2, the third node P3, and the fourth node P4 are reset; the potential of the second node P2 is VDD, the potential of the third node P3 is INIT1, and the potential of the fourth node P4 is INIT2. The above contents may be referred to for the turn-on situations of the respective transistors during the reset operation, and no details will be repeated here.

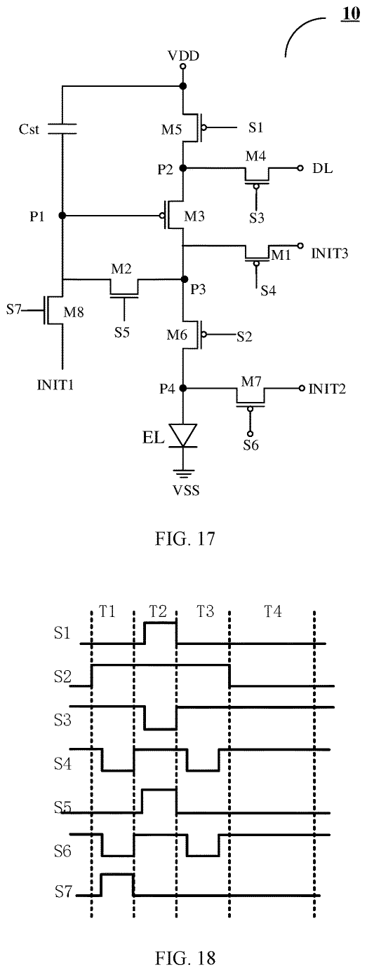

FIG. 17 is a schematic diagram of a circuit structure of the pixel circuit illustrated in FIG. 3. As illustrated in FIG. 17, the pixel circuit 10 includes: transistors M1 to M8 and a storage capacitor Cst. For example, the transistor M3 is used as a driving transistor, while other transistors are used as switch transistors. The light emitting element 170 may be implemented as a light emitting element EL; the light emitting element EL, for example, may be an OLED; and the embodiments of the present disclosure include but are not limited thereto. Hereinafter, the respective embodiments are illustrated all by taking the OLED as an example, and no details will be repeated here. The OLED may be of various types, for example, a top emission structure, a bottom emission structure, etc., and may emit red light, green light, blue light, or white light, etc., which will not be limited in the embodiments of the present disclosure.

For example, as illustrated in FIG. 17, in more detail, the driving circuit 110 may be implemented as a driving transistor, that is, the transistor M3; the data writing circuit 120 may be implemented as a data writing transistor, that is, the transistor M4; the threshold compensating circuit 130 may be implemented as a threshold compensating transistor, that is, the transistor M2; the storage circuit 140 may be implemented as a storage capacitor Cst; the first light emission control circuit 150 may be implemented as a first light emission control transistor, that is, the transistor M5; the second light emission control circuit 180 may be implemented as a second light emission control transistor, that is, the transistor M6; the first reset circuit 160 may be implemented as a first reset transistor, that is, the transistor M1; the second reset circuit 190 may be implemented as a second reset transistor, that is, the transistor M7. Connection modes of these transistors and the storage capacitor are similar to the circuit structure illustrated in FIG. 7, and no details will be repeated here.

This example differs from the circuit structure illustrated in FIG. 7 in that: a third reset circuit 210 is further included. For example, the third reset circuit 210 may be implemented as a third reset transistor, that is, the transistor M8. The gate electrode of the third reset transistor (the transistor M8) is connected with the third reset line (the scanning line S7) to receive the third reset signal; the first electrode of the third reset transistor (the transistor M8) is connected with the third reset voltage line (the voltage line INIT1) to receive the third reset voltage; and the second electrode of the third reset transistor (the transistor M8) is connected with the control terminal 113 of the driving circuit 110, that is, connected with the gate electrode of the transistor M3 at the first node P1. For example, the third reset transistor is a transistor of the second-type, for example, an N-type thin film transistor.

FIG. 18 is a timing diagram for the pixel circuit illustrated in FIG. 17 provided by some embodiments of the present disclosure. As illustrated in FIG. 18, in this example, the transistor M1 is used for resetting the drain electrode of the transistor M3 (i.e., the third node P3). In the first phase T1, the first node P1, the second node P2, the third node P3, and the fourth node P4 are reset. Then, in the second phase T2, a data writing operation is performed. In the third phase T3, the second node P2 is reset by the turned-on transistor M5, the third node P3 is reset by the turned-on transistor M1, and the fourth node P4 is reset by the turned-on transistor M7. In the fourth phase T4, the light emitting element EL emits light. The above contents may be referred to for the turn-on situations of the respective transistors during the reset operation, and no details will be repeated here.

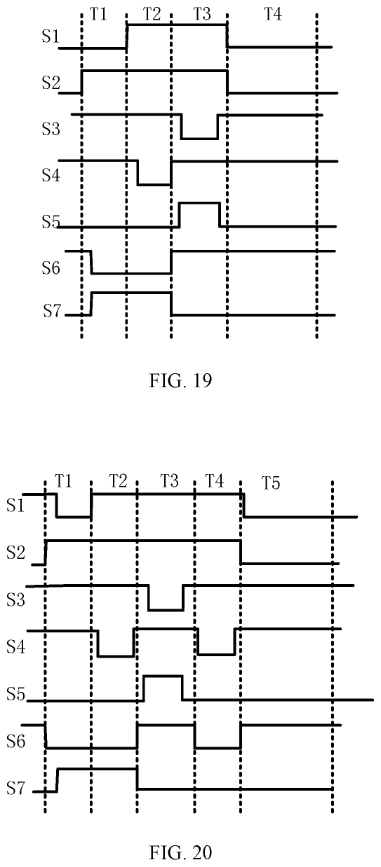

FIG. 19 is another timing diagram for the pixel circuit illustrated in FIG. 17 provided by some embodiments of the present disclosure. As illustrated in FIG. 19, in this example, in the first phase T1, the first node P1, the second node P2, and the fourth node P4 are reset; in the second phase T2, the first node P1, the third node P3, and the fourth node P4 are reset. For example, the second node P2 may be reset by the turned-on transistor M5; the third node P3 may be reset by the turned-on transistor M1; the fourth node P4 may be reset by the turned-on transistor M7; and the first node P1 may be reset by the turned-on transistor M8. In the third phase T3, a data writing operation is performed. Then, in the fourth phase T4, the light emitting element EL emits light. The above contents may be referred to for the turn-on situations of the respective transistors during the reset operation, and no details will be repeated here.

FIG. 20 is another timing diagram for the pixel circuit illustrated in FIG. 17 provided by some embodiments of the present disclosure. As illustrated in FIG. 20, in this example, in the first phase T1, the first node P1, the second node P2, and the fourth node P4 are reset; in the second phase T2, the first node P1, the third node P3, and the fourth node P4 are reset. In the third phase T3, a data write operation is performed. In the fourth phase T4, the third node P3 and the fourth node P4 are reset. In a fifth phase T5, the light emitting element EL emits light. The above contents may be referred to for the turn-on situations of the respective transistors during the reset operation, and no details will be repeated here.

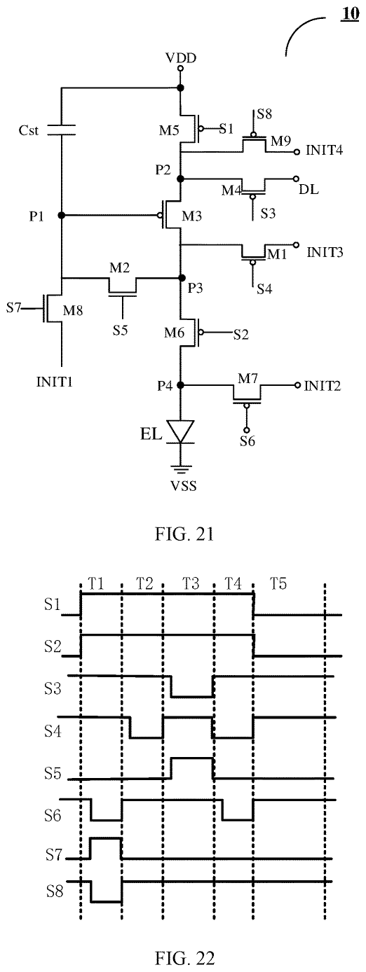

FIG. 21 is a schematic diagram of a circuit structure of the pixel circuit illustrated in FIG. 4. As illustrated in FIG. 21, the pixel circuit 10 includes: transistors M1 to M9 and a storage capacitor Cst. For example, the transistor M3 is used as a driving transistor, while other transistors are used as switch transistors. The light emitting element 170 may be implemented as a light emitting element EL; the light emitting element EL, for example, may be an OLED; and the embodiments of the present disclosure include but are not limited thereto. Hereinafter, the respective embodiments are illustrated all by taking the OLED as an example, and no details will be repeated here. The OLED may be of various types, for example, a top emission structure, a bottom emission structure, etc., and may emit red light, green light, blue light, or white light, etc., which will not be limited in the embodiments of the present disclosure.

For example, as illustrated in FIG. 21, in more detail, the driving circuit 110 may be implemented as a driving transistor, that is, the transistor M3; the data writing circuit 120 may be implemented as a data writing transistor, that is, the transistor M4; the threshold compensating circuit 130 may be implemented as a threshold compensating transistor, that is, the transistor M2; the storage circuit 140 may be implemented as a storage capacitor Cst; the first light emission control circuit 150 may be implemented as a first light emission control transistor, that is, the transistor M5; the second light emission control circuit 180 may be implemented as a second light emission control transistor, that is, the transistor M6; the first reset circuit 160 may be implemented as a first reset transistor, that is, the transistor M1; the second reset circuit 190 may be implemented as a second reset transistor, that is, the transistor M7; and the third reset circuit 210 may be implemented as a third reset transistor, that is, the transistor M8. Connection modes of these transistors and the storage capacitor are similar to the circuit structure illustrated in FIG. 17, and no details will be repeated here.

This example differs from the circuit structure illustrated in FIG. 17 in that: a fourth reset circuit 220 is further provided. For example, the fourth reset circuit 220 may be implemented as a fourth reset transistor, that is, the transistor M9. A gate electrode of the fourth reset transistor (the transistor M9) is connected with the fourth reset line (the scanning line S8) to receive the fourth reset signal; a first electrode of the fourth reset transistor (the transistor M9) is connected with the fourth reset voltage line (the voltage line INIT4) to receive the fourth reset voltage; and a second electrode of the fourth reset transistor (the transistor M9) is connected with the first terminal 111 of the driving circuit 110, that is, connected with the first electrode of the transistor M3 at the second node P2.

FIG. 22 is a timing diagram for the pixel circuit illustrated in FIG. 21 provided by some embodiments of the present disclosure. As illustrated in FIG. 22, in this example, in the first phase T1, the first node P1 is reset by the turned-on transistor M8; and the second node P2 and the fourth node P4 are reset respectively by the turned-on transistor M9 and the turned-on transistor M7. In the second phase T2, the third node P3 is reset by the turned-on transistor M1. In the third phase T3, a data writing operation is performed. In the fourth phase T4, the third node P3 and the fourth node P4 are respectively reset again by the turned-on transistor M1 and the turned-on transistor M7. In the fifth phase T5, the light emitting element EL emits light. The above contents may be referred to for the turn-on situations of the respective transistors during the reset operation, and no details will be repeated here.

The timing is simulated under simulation conditions of: VINT4 being 6 V, VINT1 being −3 V or −4 V, VINT2 being −3 V, and VINT3 respectively being 0 V, 1 V, 2 V, 3 V and 4 V. When different voltage values are taken for VINT3, good simulation effects are always achieved. For example, the potential of VINT3 may be 0 V, 1 V, 2 V, 3 V, 4 V, and the value thereof may be selected according to actual needs. If quick reset is required for a high-frequency scenario, a value of a low potential may be selected, for example, 0 V; if slow reset is required for a low-frequency scenario, a potential close to the data voltage may be selected, for example, 3 V or 4 V.

In this example, a potential of the third node P3 after being reset by the first reset transistor (the transistor M1) is greater than a potential of the fourth node P4 after being reset by the second reset transistor (the transistor M7); a potential of the first node P1 after being reset by the third reset transistor (the transistor M8) is less than the potential of the third node P3 after being reset by the first reset transistor (the transistor M1); the potential of the first node P1 after being reset by the third reset transistor (the transistor M8) is less than or equal to a potential of the fourth node P4 after being reset by the second reset transistor (the transistor M7); a potential of the second node P2 after being reset by the fourth reset transistor (the transistor M9) is greater than the potential of the first node P1 after being reset by the third reset transistor (the transistor M8); the potential of the second node P2 after being reset by the fourth reset transistor (the transistor M9) is greater than the potential of the third node P3 after being reset by the first reset transistor (the transistor M1); and the potential of the second node P2 after being reset by the fourth reset transistor (the transistor M9) is greater than the potential of the fourth node P4 after being reset by the second reset transistor (the transistor M7). Thus, a better reset effect may be achieved, and effects of residual charges are better reduced.

For example, with respect to the timing illustrated in FIG. 22, reset situations within one-frame time may be different at different operation frequencies. For example, in a low-frequency situation, for example, equal to 30 Hz or lower than 30 Hz, the first node P1, the second node P2, the third node P3, and the fourth node P4 are all reset. Time for completing reset is sufficient during low-frequency operation, and the transistors in the pixel circuit are more prone to electric leakage in a low-frequency state, so sufficient reset is favorable for alleviating a hysteresis effect and thus enhancing display image quality. For example, in a medium-frequency situation, for example, from 30 Hz to 90 Hz, fewer nodes than those in the low-frequency state may be selected and reset, for example, three nodes are reset, that is, the first node P1, the second node P2, and the fourth node P4 are reset, or the first node P1, the third node P3, and the fourth node P4 are reset. In the high-frequency operation state, for example, at frequencies from 90 Hz to 120 Hz or even higher, fewer nodes than those in the medium-frequency state/low-frequency state may be selected and reset, for example, the first node P1 and the fourth node P4 are reset, or only one of the first node P1 and the fourth node P4 is reset. The higher the frequency, the fewer the nodes reset, which is favorable for fast data writing within a short period of time and further implementing high refresh rates. Moreover, in the high-frequency operation state, decrease in the number of reset nodes is favorable for further reducing power consumption.

For example, in order to be capable of resetting the second node P2 while reducing the number of transistors in the pixel circuit, a voltage generating circuit separately provided may be adopted to generate three types of voltage signals for use by the pixel circuit, that is, voltage signals of VDD1, VDD2, and VSS, or two signal lines are connected at the first voltage line VDD to respectively transmit VDD1 and VDD2. The amplitude relationship of the three is: VDD1> VDD2>VSS. In the non-light-emitting phase, the signal connected with the first voltage line VDD is VDD2; in the light emitting phase, the signal connected with the first voltage line VDD is VDD1. Therefore, the transistor M9 in FIG. 21 may be omitted. Of course, the embodiments of the present disclosure are not limited thereto, and the first voltage transmitted on the first voltage line VDD may also be constant, which will not be limited in the embodiments of the present disclosure.

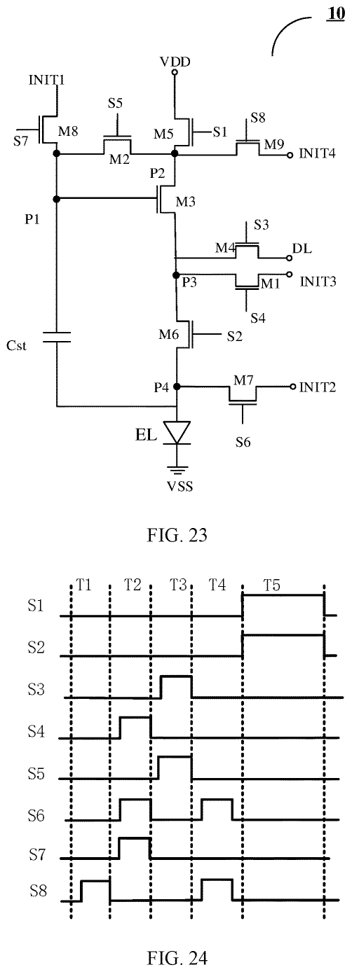

FIG. 23 is a schematic diagram of a circuit structure of a pixel circuit provided by some embodiments of the present disclosure. In some examples, as illustrated in FIG. 23, the pixel circuit 10 includes: transistors M1 to M9 and a storage capacitor Cst. For example, the transistor M3 is used as a driving transistor, while other transistors are used as switch transistors. The light emitting element 170 may be implemented as a light emitting element EL; the light emitting element EL, for example, may be an OLED; and the embodiments of the present disclosure include but are not limited thereto. Hereinafter, the respective embodiments will be illustrated all by taking the OLED as an example, and no details will be repeated here. The OLED may be of various types, for example, a top emission structure, a bottom emission structure, etc., and may emit red light, green light, blue light, or white light, etc., which will not be limited in the embodiments of the present disclosure.

For example, as illustrated in FIG. 23, in more detail, the driving circuit 110 may be implemented as a driving transistor, that is, the transistor M3; the data writing circuit 120 may be implemented as a data writing transistor, that is, the transistor M4; the threshold compensating circuit 130 may be implemented as a threshold compensating transistor, that is, the transistor M2; the storage circuit 140 may be implemented as a storage capacitor Cst; the first light emission control circuit 150 may be implemented as a first light emission control transistor, that is, the transistor M5; the second light emission control circuit 180 may be implemented as a second light emission control transistor, that is, the transistor M6; the first reset circuit 160 may be implemented as a first reset transistor, that is, the transistor M1; the second reset circuit 190 may be implemented as a second reset transistor, that is, the transistor M7; the third reset circuit 210 may be implemented as a third reset transistor, that is, the transistor M8; and the fourth reset circuit 220 may be implemented as a fourth reset transistor, that is, the transistor M9. The operation principle of the pixel circuit 10 in this example is basically the same as the operation principle of the pixel circuit 10 illustrated in FIG. 21, and the difference rests in that all transistors in the pixel circuit 10 in this example are N-type thin film transistors. The above contents may be referred to for relevant principles, and no details will be repeated here.

FIG. 24 is a timing diagram for the pixel circuit illustrated in FIG. 23 provided by some embodiments of the present disclosure. In the example, in the first phase T1, the second node P2 is reset by the turned-on transistor M9. In the second phase T2, the third node P3 is reset through the turned-on transistor M1, the fourth node P4 is reset by the turned-on transistor M7, and the first node P1 is reset by the turned-on transistor M8. In the third phase T3, a data writing operation is performed. In the fourth phase T4, the fourth node P4 and the second node P2 are respectively reset again by the turned-on transistor M7 and the turned-on transistor M9. In the fifth phase T5, the light emitting element EL emits light.

It should be noted that a plurality of examples are described above in conjunction with FIG. 7 to FIG. 24. Although the reset operations on the first node P1, the second node P2, the third node P3, and the fourth node P4 are described in a specific order in these examples, this does not constitute a limitation on the embodiments of the present disclosure. The order of the reset operations on the first node P1, the second node P2, the third node P3, and the fourth node P4 may not be limited to the situations described in the embodiments of the present disclosure, but may be adjusted and modified according to actual situations, and is not limited in the embodiments of the present disclosure. In the embodiments of the present disclosure, one or more nodes among the first node P1, the second node P2, the third node P3, and the fourth node P4 may be selected and reset, and may be reset before the data writing phase and/or between the data writing phase and the light emitting phase (i.e., after the data writing phase and before the light emitting phase). The selected nodes may be reset in any applicable order and mode, which is not limited in the embodiments of the present disclosure.

It should be noted that although the reset operations on the respective nodes are described above for specific circuit structures, this does not constitute a limitation on the embodiments of the present disclosure. The driving method provided by the embodiments of the present disclosure may also be applied to other circuit structures, not limited to the circuit structures illustrated in FIG. 2 to FIG. 5, FIG. 7, FIG. 12, FIG. 17, FIG. 21, and FIG. 23, and not limited to the pixel circuit containing 7 transistors or 8 transistors or 9 transistors, and the driving method can be applied to any applicable pixel circuit.

In the embodiments of the present disclosure, the nodes on the data writing path are reset before writing data, and in this way, effects of residual charges occurred in the previous phase (including residual charges caused by a leakage current) can be eliminated, so that data can be accurately written into the gate electrode of the driving transistor. The nodes on the light emitting path are reset before emitting light. Since the light emitting phase occurs after writing data, the light emitting path may have residual charges generated thereon after writing data, and the light emitting path may also have residual charges generated thereon due to electric leakage of some transistors. Therefore, by resetting positions or nodes that may have residual charges before emitting light, accuracy of the light emitting current on the light emitting path can be significantly improved and display quality is further improved.

It should be noted that in the respective embodiments of the present disclosure, the storage capacitor Cst may be a capacitor device fabricated through a process, for example, the capacitor device is implemented through fabricating specialized capacitor electrodes, the respective electrodes of the capacitor may be implemented through metal layers, semiconductor layers (e.g., doped polysilicon), etc. Moreover, the storage capacitor Cst may also be a parasitic capacitor between transistors, and may be implemented through the transistor per se and other devices and wires.

It should be noted that in the illustrations of the respective embodiments of the present disclosure, the first node P1, the second node P2, the third node P3, and the fourth node P4 do not represent actual components, but rather represent convergence points of relevant electrical connections in the circuit diagram.

It should be noted that, the transistors adopted in the embodiments of the present disclosure may all be thin film transistors, field effect transistors, or other switching devices with same characteristics, and the embodiments of the present disclosure are all described by taking the thin film transistor as an example. The source electrode and the drain electrode of the transistor adopted here may be symmetrical in structure, so the source electrode and the drain electrode of the transistor may be structurally indistinguishable. In the embodiments of the present disclosure, in order to distinguish two electrodes of a transistor other than a gate electrode, one electrode is directly described as a first electrode, and the other electrode is described as a second electrode.

Furthermore, in the embodiments of the present disclosure, when the N-type transistor is adopted, a first electrode of the transistor is a drain electrode, and a second electrode is a source electrode; when the P-type transistor is adopted, a first electrode of the transistor is a source electrode, and a second electrode is a drain electrode. When changing the type of transistor, it is only necessary to simply connect the respective electrodes of the selected type of transistor with reference to the respective electrodes of the corresponding transistor according to the embodiments of the present disclosure, and make corresponding voltage terminals supply corresponding high voltage or low voltage. When an N-type transistor is adopted, an active layer of the thin film transistor may be made of indium gallium zinc oxide (IGZO), and as compared with an active layer of the thin film transistor made of low temperature poly silicon (LTPS) or amorphous silicon (e.g., hydrogenated amorphous silicon), may effectively reduce the size of the transistor and prevent leakage current.

At least one embodiment of the present disclosure further provides a pixel circuit. The pixel circuit includes: a driving circuit, a data writing circuit, a threshold compensating circuit, a storage circuit, a first light emission control circuit, and a first reset circuit. The driving circuit includes a control terminal, a first terminal, and a second terminal, and is configured to control a drive current flowing through a light emitting element. The data writing circuit is connected with the first terminal of the driving circuit, and is configured to write a data signal into the first terminal of the driving circuit in response to a first scanning signal in a data writing phase. The threshold compensating circuit is connected between the control terminal of the driving circuit and the second terminal of the driving circuit, and is configured to write a compensation signal based on the data signal into the control terminal of the driving circuit in response to a second scanning signal. The storage circuit is connected with the control terminal of the driving circuit and a first voltage line, the storage circuit is connected with the control terminal of the driving circuit at the first node, and the storage circuit is configured to store the compensation signal and keep the compensation signal at the control terminal of the driving circuit. The first light emission control circuit is connected with the first voltage line and the first terminal of the driving circuit, the first light emission control circuit is connected with the first terminal of the driving circuit at the second node, and the first light emission control circuit is configured to apply a first voltage supplied by the first voltage line to the first terminal of the driving circuit in response to a first light emission control signal before the data writing phase, so as to reset the second node. The first reset circuit is connected with the threshold compensating circuit, and is configured to apply a first reset voltage to the control terminal of the driving circuit in response to a first reset signal before the data writing phase, so as to reset the first node. The pixel circuit can reduce or eliminate effects of residual charges on accuracy of data writing and the potential of the anode of the light emitting device in the light emitting phase, and optimize the display effect. The above illustration about the pixel circuit 10 illustrated in FIG. 2 to FIG. 5 may be referred to for detailed illustration of the pixel circuit, and no details will be repeated here.

At least one embodiment of the present disclosure further provides a pixel circuit. The pixel circuit includes: a driving circuit, a data writing circuit, a threshold compensating circuit, a storage circuit, and a first reset circuit. The driving circuit includes a control terminal, a first terminal, and a second terminal, and is configured to control a drive current flowing through a light emitting element. The data writing circuit is connected with the first terminal of the driving circuit, and is configured to write a data signal into the first terminal of the driving circuit in response to a first scanning signal. The threshold compensating circuit is connected between the control terminal of the driving circuit and the second terminal of the driving circuit, and is configured to write a compensation signal based on the data signal into the control terminal of the driving circuit in response to a second scanning signal. The storage circuit is connected with the control terminal of the driving circuit and a first voltage line, and is configured to store the compensation signal and keep the compensation signal at the control terminal of the driving circuit. The first reset circuit is connected with the threshold compensating circuit and the second terminal of the driving circuit, and is configured to apply a first reset voltage to the second terminal of the driving circuit in response to a first reset signal. The pixel circuit is, for example, the pixel circuit 10 illustrated in FIG. 2, FIG. 3, and FIG. 4. The illustration about the driving circuit 110, the data writing circuit 120, the threshold compensating circuit 130, the storage circuit 140, and the first reset circuit 160 in the pixel circuit 10 illustrated in FIG. 2, FIG. 3, and FIG. 4 may be referred to for detailed illustration about the driving circuit, the data writing circuit, the threshold compensating circuit, the storage circuit, and the first reset circuit, and no details will be repeated here.

For example, the driving circuit includes a driving transistor; a gate electrode of the driving transistor serves as the control terminal of the driving circuit; a first electrode of the driving transistor serves as the first terminal of the driving circuit; and a second electrode of the driving transistor serves as the second terminal of the driving circuit.

For example, the data writing circuit includes a data writing transistor; a gate electrode of the data writing transistor is connected with a first scanning line to receive the first scanning signal; a first electrode of the data writing transistor is connected with a data line to receive the data signal; and a second electrode of the data writing transistor is connected with the first electrode of the driving transistor.

For example, the threshold compensating circuit includes a threshold compensating transistor; a gate electrode of the threshold compensating transistor is connected with a second scanning line to receive a second scanning signal; a first electrode of the threshold compensating transistor is connected with the second electrode of the driving transistor; and a second electrode of the threshold compensating transistor is connected with the gate electrode of the driving transistor.

For example, the storage circuit includes a storage capacitor; a first electrode of the storage capacitor is connected with the first voltage line; and a second electrode of the storage capacitor is connected with the gate electrode of the driving transistor.

For example, the first reset circuit includes a first reset transistor; a gate electrode of the first reset transistor is connected with a first reset line to receive the first reset signal; a first electrode of the first reset transistor is connected with a first reset voltage line to receive the first reset voltage; and a second electrode of the first reset transistor is connected with the second electrode of the driving transistor.

Connection modes of the respective transistors and the storage capacitor in the pixel circuit 10 illustrated in FIG. 7, FIG. 17, and FIG. 21 may be referred to for specific connection modes of the respective transistors and the storage capacitor. The driving transistor, for example, is the transistor M3; the data writing transistor, for example, is the transistor M4; the threshold compensating transistor, for example, is the transistor M2; the storage capacitor, for example, is the storage capacitor Cst; and the first reset transistor, for example, is the transistor M1. No details will be repeated here.

In some examples, the pixel circuit further includes a first light emission control circuit and a second light emission control circuit. The first light emission control circuit is connected with the first voltage line and the first terminal of the driving circuit, and is configured to apply the first voltage supplied by the first voltage line to the first terminal of the driving circuit in response to a first light emission control signal. The second light emission control circuit is connected with the second terminal of the driving circuit and the light emitting element, and is configured to apply a voltage of the second terminal of the driving circuit to the light emitting element in response to a second light emission control signal. The illustration about the first light emission control circuit 150 and the second light emission control circuit 180 in the pixel circuit 10 illustrated in FIG. 2, FIG. 3, and FIG. 4 may be referred to for detailed illustration about the first light emission control circuit and the second light emission control circuit, and no details will be repeated here.

For example, the first light emission control circuit includes a first light emission control transistor; a gate electrode of the first light emission control transistor is connected with a first light emission control line to receive the first light emission control signal; a first electrode of the first light emission control transistor is connected with the first voltage line; and a second electrode of the first light emission control transistor is connected with the first terminal of the driving circuit. For example, the second light emission control circuit includes a second light emission control transistor; a gate electrode of the second light emission control transistor is connected with a second light emission control line to receive the second light emission control signal; a first electrode of the second light emission control transistor is connected with the second terminal of the driving circuit; and a second electrode of the second light emission control transistor is connected with the light emitting element. The connection modes of the respective transistors in the pixel circuit 10 illustrated in FIG. 7, FIG. 17, and FIG. 21 may be referred to for specific connection modes of the respective transistors. The first light emission control transistor, for example, is the transistor M5; the second light emission control transistor, for example, is the transistor M6; and no details will be repeated here.

In some examples, the pixel circuit further includes a second reset circuit. The second reset circuit is connected with the second light emission control circuit and the light emitting element, and is configured to apply the second reset voltage to the light emitting element in response to a second reset signal. The above illustration about the second reset circuit 190 in the pixel circuit 10 illustrated in FIG. 2, FIG. 3, and FIG. 4 may be referred to for detailed illustration about the second reset circuit, and no details will be repeated here.

For example, the second reset circuit includes a second reset transistor; a gate electrode of the second reset transistor is connected with a second reset line to receive the second reset signal; a first electrode of the second reset transistor is connected with a second reset voltage line to receive the second reset voltage; and a second electrode of the second reset transistor is connected with the second electrode of the second light emission control transistor and the light emitting element. The connection modes of the respective transistors in the pixel circuit 10 illustrated in FIG. 7, FIG. 17, and FIG. 21 may be referred to for specific connection modes of the respective transistors. The second reset transistor, for example, is the transistor M7, and no details will be repeated here.

In some examples, the pixel circuit further includes a third reset circuit. The third reset circuit is connected with the threshold compensating circuit and the control terminal of the driving circuit, and the third reset circuit is configured to apply a third reset voltage to the control terminal of the driving circuit in response to a third reset signal. The above illustration about the third reset circuit 210 in the pixel circuit 10 illustrated in FIG. 3 and FIG. 4 may be referred to for detailed illustration about the third reset circuit, and no details will be repeated here.

For example, the third reset circuit includes a third reset transistor; a gate electrode of the third reset transistor is connected with a third reset line to receive the third reset signal; a first electrode of the third reset transistor is connected with a third reset voltage line to receive the third reset voltage; and a second electrode of the third reset transistor is connected with the control terminal of the driving circuit. The connection modes of the respective transistors in the pixel circuit 10 illustrated in FIG. 17 and FIG. 21 may be referred to for specific connection modes of the respective transistors. The third reset transistor, for example, is the transistor M8, and no details will be repeated here.

For example, in some examples, the pixel circuit further includes a fourth reset circuit. The fourth reset circuit is connected with the first terminal of the driving circuit, and the fourth reset circuit is configured to apply a fourth reset voltage to the first terminal of the driving circuit in response to a fourth reset signal. The above illustration about the fourth reset circuit 220 in the pixel circuit 10 illustrated in FIG. 4 may be referred to for detailed illustration about the fourth reset circuit, and no details will be repeated here.

For example, the fourth reset circuit includes a fourth reset transistor; a gate electrode of the fourth reset transistor is connected with a fourth reset line to receive the fourth reset signal; a first electrode of the fourth reset transistor is connected with a fourth reset voltage line to receive the fourth reset voltage; and a second electrode of the fourth reset transistor is connected with the first terminal of the driving circuit. The connection modes of the respective transistors in the pixel circuit 10 illustrated in FIG. 21 may be referred to for specific connection modes of the respective transistors. The fourth reset transistor, for example, is the transistor M9, and no details will be repeated here.

At least one embodiment of the present disclosure further provides a display panel. The display panel includes a plurality of pixel units, and each pixel unit includes the pixel circuit provided by any one embodiment of the present disclosure. The display panel can reduce or eliminate effects of residual charges on accuracy of data writing and the potential of the anode of the light emitting device in the light emitting phase, and optimize the display effect.

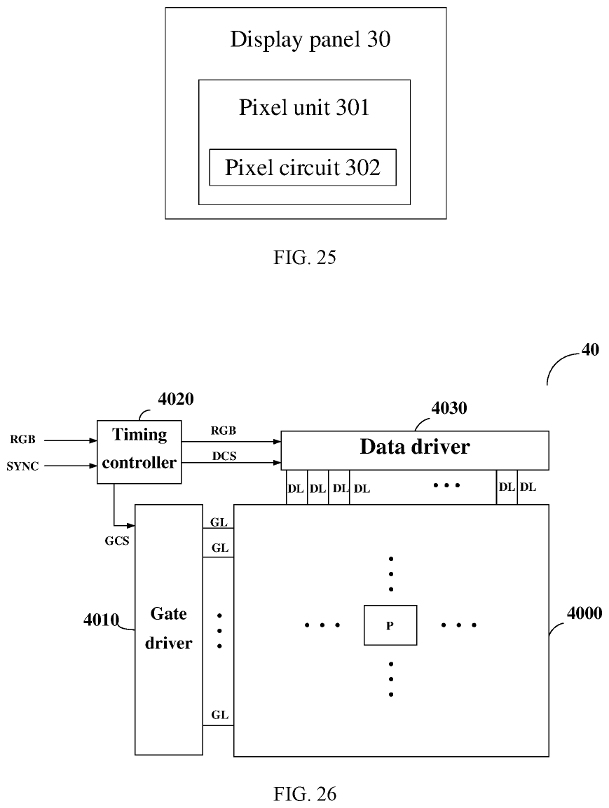

FIG. 25 is a schematic block diagram of a display panel provided by some embodiments of the present disclosure. As illustrated in FIG. 25, in some embodiments, the display panel 30 includes a plurality of pixel units 301. The plurality of pixel units 301, for example, are arranged in an array. Each pixel unit 301 includes a pixel circuit 302. The pixel circuit 302 may be the pixel circuit provided by any one embodiment of the present disclosure, for example, the pixel circuit 10 as described above.

For example, the display panel 30 may be an organic light emitting diode (OLED) display panel, a quantum dot light-emitting diode (QLED) display panel, or other applicable display panel. Each pixel unit 301 not only includes a pixel circuit 302, but also includes a light emitting element (e.g., an OLED, a QLED, etc.).

For example, the display panel 30 may be a rectangular panel, a circular panel, an elliptical panel, or a polygonal panel, etc. In addition, the display panel 30 may be a flat panel, or may also be a curved panel, or even a spherical panel, etc. For example, the display panel 30 may also have a touch function, that is, the display panel 30 may be a touch display panel. For example, display panel 30 may be applied to a mobile phone, a tablet personal computer, a television, a monitor, a laptop, a digital photo frame, a navigator, and any other product or component having a display function. For example, the display panel 30 may be a flexible display panel, and thus may meet various actual application requirements, and for example, the display panel 30 may be applied to a curved screen, etc.

For clarity and conciseness, the embodiments of the present disclosure do not provide all constituent units of the display panel 30. In order to implement basic functions of the display panel 30, those skilled in the art may provide and arrange other structures not illustrated according to specific needs, which will not be limited in the embodiments of the present disclosure.

The technical effects of the pixel circuit 10 provided by the embodiments of the present disclosure may be referred to for technical effects of the display panel 30 provided by the above-described embodiments, and no details will be repeated here.

At least one embodiment of the present disclosure further provides a display device. The display device includes the display panel provided by any one embodiment of the present disclosure. The display device can reduce or eliminate effects of residual charges on accuracy of data writing and the potential of the anode of the light emitting device in the light emitting phase, and optimize the display effect.

FIG. 26 is a schematic block diagram of a display device provided by some embodiments of the present disclosure. As illustrated in FIG. 26, the display device 40 includes a display panel 4000, a gate driver 4010, a timing controller 4020, and a data driver 4030. The display panel 4000 includes a plurality of pixel units P defined by a plurality of gate lines GL and a plurality of data lines DL intersecting with each other. The display panel 4000 is, for example, the display panel provided by any one embodiment of the present disclosure, for example, the display panel 30 as described above. The plurality of gate lines GL include the first scanning line SC1, the second scanning line SC2, the third scanning line SC3, the first light emission control line EM1, the second light emission control line EM2, etc., as described above. The plurality of data lines DL include the data line Vdata as described above. The gate driver 4010 is used for driving the plurality of gate lines GL; the data driver 4030 is used for driving the plurality of data lines DL; the timing controller 4020 is used for processing image data RGB input from outside the display device 40, supplying processed image data RGB to the data driver 4030, and outputting gate control signals GCS and data control signals DCS to the gate driver 4010 and the data driver 4030, so as to control the gate driver 4010 and the data driver 4030.

For example, the gate driver 4010 may be implemented as a semiconductor chip, or may also be integrated into the display panel 4000 to form a GOA circuit.

For example, the data driver 4030 converts the digital image data RGB input from the timing controller 4020 into data signals by using a reference gamma voltage according to the plurality of data control signals DCS originated from the timing controller 4020. The data driver 4030 supplies the converted data signals to the plurality of data lines DL. For example, the data driver 4030 may be implemented as a semiconductor chip.

For example, the timing controller 4020 processes the externally input image data RGB to match the size and resolution of the display panel 4000, and then supplies the processed image data to the data driver 4030. The timing controller 4020 generates a plurality of gate control signals GCS and a plurality of data control signals DCS by using synchronization signals (e.g., a dot clock signal DCLK, a data enable signal DE, a horizontal synchronization signal Hsync, and a vertical synchronization signal Vsync) input from outside the display device 40. The timing controller 4020 supplies the gate control signal GCS and the data control signal DCS generated respectively to the gate driver 4010 and the data driver 4030, for controlling the gate driver 4010 and the data driver 4030.

The display device 40 may further include other components, for example, a signal decoding circuit, a voltage converting circuit, etc.; these components, for example, may be existing conventional components, and no details will be repeated here. The display device 40 may be applied to an e-book, a mobile phone, a tablet personal computer, a television, a monitor, a laptop, a digital photo frame, a navigator, and any other products or components having a display function. The description of the pixel circuit 10 and the display panel 30 according to the embodiments of the present disclosure may be referred to for detailed description of the display device 40, and no details will be repeated here.

The following statements should be noted.
(1) The accompanying drawings involve only the structure(s) in connection with the embodiment(s) of the present disclosure, and other structure(s) can be referred to common design(s).
(2) In case of no conflict, features in one embodiment or in different embodiments can be combined to obtain new embodiments.

What have been described above are only specific implementations of the present disclosure, the protection scope of the present disclosure is not limited thereto, and the protection scope of the present disclosure should be based on the protection scope of the claims.

1. A method for driving a pixel circuit,
wherein the pixel circuit comprises a driving circuit, a data writing circuit, a threshold compensating circuit, a storage circuit, a first light emission control circuit, and a first reset circuit;
the driving circuit comprises a control terminal, a first terminal, and a second terminal, and is configured to control a drive current flowing through a light emitting element;
the data writing circuit is connected with the first terminal of the driving circuit, and is configured to write a data signal into the first terminal of the driving circuit in response to a first scanning signal;
the threshold compensating circuit is connected between the control terminal of the driving circuit and the second terminal of the driving circuit, and is configured to write a compensation signal based on the data signal into the control terminal of the driving circuit in response to a second scanning signal;
the storage circuit is connected with the control terminal of the driving circuit and a first voltage line, and is configured to store the compensation signal and keep the compensation signal at the control terminal of the driving circuit;
the first light emission control circuit is connected with the first voltage line and the first terminal of the driving circuit, and is configured to apply a first voltage supplied by the first voltage line to the first terminal of the driving circuit in response to a first light emission control signal;
the first reset circuit is connected with the threshold compensating circuit, and is configured to apply a first reset voltage to the control terminal of the driving circuit in response to a first reset signal;
the control terminal of the driving circuit is connected with the storage circuit at a first node, and the first light emission control circuit is connected with the first terminal of the driving circuit at a second node; and
the method comprises:
before a data writing phase, the first reset circuit turning on in response to the first reset signal to apply the first reset voltage to the control terminal of the driving circuit, so as to reset the first node, and the first light emission control circuit turning on in response to the first light emission control signal to apply the first voltage to the first terminal of the driving circuit, so as to reset the second node;
during the data writing phase, the data writing circuit turning on in response to the first scanning signal, so as to write the data signal into the first terminal of the driving circuit; and
during a light emitting phase, the first light emission control circuit turning on in response to the first light emission control signal, and the light emitting element emitting light according to the drive current.

2. The method according to claim 1, wherein the first reset circuit turning on in response to the first reset signal to apply the first reset voltage to the control terminal of the driving circuit, so as to reset the first node, comprises:
the first reset circuit turning on in response to the first reset signal, and the threshold compensating circuit turning on in response to the second scanning signal, to apply the first reset voltage to the control terminal of the driving circuit through a path formed by the first reset circuit and the threshold compensating circuit, so as to reset the first node.

3. The method according to claim 1, wherein the pixel circuit further comprises a second light emission control circuit and a second reset circuit;
the second light emission control circuit is connected with the second terminal of the driving circuit and the light emitting element, and is configured to apply a voltage of the second terminal of the driving circuit to the light emitting element in response to a second light emission control signal;
the second reset circuit is connected with the second light emission control circuit and the light emitting element, and is configured to apply a second reset voltage to the light emitting element in response to a second reset signal;
the second light emission control circuit is connected with the second terminal of the driving circuit at a third node, and the second reset circuit is connected with the second light emission control circuit and the light emitting element at a fourth node; and
the method further comprises:
before the data writing phase, the first reset circuit applying the first reset voltage to the second terminal of the driving circuit while the first reset circuit resets the first node, so as to reset the third node; and/or
before the data writing phase, the second reset circuit turning on in response to the second reset signal, to apply the second reset voltage to the light emitting element, so as to reset the fourth node.

4. The method according to claim 1, wherein, before the data writing phase, the first node and the second node are reset simultaneously, or reset separately in different time periods.

5. The method according to claim 3, wherein, before the data writing phase, in a case of resetting both the third node and the fourth node, the third node and the fourth node are reset simultaneously, or reset separately in different time periods.

6. The method according to claim 5, wherein, before the data writing phase, a reset period of at least one of the third node or the fourth node coincides with a reset period of at least one of the first node or the second node.

7. The method according to claim 5, wherein, before the data writing phase, none of a reset period of the first node, a reset period of the second node, a reset period of the third node, and a reset period of the fourth node coincides.

8. The method according to claim 3, further comprising:
after the data writing phase and before the light emitting phase, the first light emission control circuit turning on in response to the first light emission control signal, to apply the first voltage to the first terminal of the driving circuit, so as to reset the second node; and/or
after the data writing phase and before the light emitting phase, the first reset circuit turning on in response to the first reset signal, to apply the first reset voltage to the second terminal of the driving circuit, so as to reset the third node; and/or
after the data writing phase and before the light emitting phase, the second reset circuit turning on in response to the second reset signal, to apply the second reset voltage to the light emitting element, so as to reset the fourth node.

9. The method according to claim 8, wherein, after the data writing phase and before the light emitting phase, at least two nodes among the second node, the third node, and the fourth node are reset simultaneously, or reset separately in different time periods.

10. The method according to claim 1, wherein the driving circuit comprises a driving transistor, the data writing circuit comprises a data writing transistor, the threshold compensating circuit comprises a threshold compensating transistor, the first light emission control circuit comprises a first light emission control transistor, and the first reset circuit comprises a first reset transistor;
the driving transistor, the data writing transistor, the first light emission control transistor, and the first reset transistor are transistors of a first type;
the threshold compensating transistor is a transistor of a second type; and
the first type is different from the second type.

11. (canceled)

12. The method according to claim 10, wherein the pixel circuit further comprises an anti-creeping circuit, the anti-creeping circuit is connected with the control terminal of the driving circuit, the threshold compensating circuit, and the storage circuit, and the anti-creeping circuit is configured to suppress electric leakage at the control terminal of the driving circuit.

13. (canceled)

14. A pixel circuit, comprising: a driving circuit, a data writing circuit, a threshold compensating circuit, a storage circuit, and a first reset circuit;
wherein the driving circuit comprises a control terminal, a first terminal, and a second terminal, and is configured to control a drive current flowing through the light emitting element;
the data writing circuit is connected with the first terminal of the driving circuit, and is configured to write a data signal into the first terminal of the driving circuit in response to a first scanning signal;
the threshold compensating circuit is connected between the control terminal of the driving circuit and the second terminal of the driving circuit, and is configured to write a compensation signal based on the data signal into the control terminal of the driving circuit in response to a second scanning signal;
the storage circuit is connected with the control terminal of the driving circuit and a first voltage line, and is configured to store the compensation signal and keep the compensation signal at the control terminal of the driving circuit, and the control terminal of the driving circuit is connected with the storage circuit at a first node;
the first reset circuit is connected with the threshold compensating circuit and the second terminal of the driving circuit, and is configured to apply a first reset voltage to the second terminal of the driving circuit in response to a first reset signal.

15. The pixel circuit according to claim 14,
wherein the driving circuit comprises a driving transistor, a gate electrode of the driving transistor serves as the control terminal of the driving circuit, a first electrode of the driving transistor serves as the first terminal of the driving circuit, and a second electrode of the driving transistor serves as the second terminal of the driving circuit;
the data writing circuit comprises a data writing transistor, a gate electrode of the data writing transistor is connected with a first scanning line to receive the first scanning signal, a first electrode of the data writing transistor is connected with a data line to receive the data signal, and a second electrode of the data writing transistor is connected with the first electrode of the driving transistor;
the threshold compensating circuit comprises a threshold compensating transistor, a gate electrode of the threshold compensating transistor is connected with a second scanning line to receive the second scanning signal, a first electrode of the threshold compensating transistor is connected with the second electrode of the driving transistor, and a second electrode of the threshold compensating transistor is connected with the gate electrode of the driving transistor;
the storage circuit comprises a storage capacitor, a first electrode of the storage capacitor is connected with the first voltage line, and a second electrode of the storage capacitor is connected with the gate electrode of the driving transistor; and
the first reset circuit comprises a first reset transistor, a gate electrode of the first reset transistor is connected with a first reset line to receive the first reset signal, a first electrode of the first reset transistor is connected with a first reset voltage line to receive the first reset voltage, and a second electrode of the first reset transistor is connected with the second electrode of the driving transistor.

16. The pixel circuit according to claim 14, further comprising a first light emission control circuit and a second light emission control circuit,
wherein the first light emission control circuit is connected with the first voltage line and the first terminal of the driving circuit, and is configured to apply a first voltage supplied by the first voltage line to the first terminal of the driving circuit in response to a first light emission control signal, and the first light emission control circuit is connected with the first terminal of the driving circuit at a second node; and
the second light emission control circuit is connected with the second terminal of the driving circuit and the light emitting element, and is configured to apply a voltage of the second terminal of the driving circuit to the light emitting element in response to a second light emission control signal, and the second light emission control circuit is connected with the second terminal of the driving circuit at a third node.

17. The pixel circuit according to claim 16,
wherein the first light emission control circuit comprises a first light emission control transistor, a gate electrode of the first light emission control transistor is connected with a first light emission control line to receive the first light emission control signal, a first electrode of the first light emission control transistor is connected with the first voltage line, and a second electrode of the first light emission control transistor is connected with the first terminal of the driving circuit; and
the second light emission control circuit comprises a second light emission control transistor, a gate electrode of the second light emission control transistor is connected with a second light emission control line to receive the second light emission control signal, a first electrode of the second light emission control transistor is connected with the second terminal of the driving circuit, and a second electrode of the second light emission control transistor is connected with the light emitting element.

18. The pixel circuit according to claim 17, further comprising a second reset circuit, wherein the second reset circuit is connected with the second light emission control circuit and the light emitting element, and is configured to apply a second reset voltage to the light emitting element in response to a second reset signal;
the second reset circuit is connected with the second light emission control circuit and the light emitting element at a fourth node; and
a potential of the third node after being reset by the first reset circuit is greater than a potential of the fourth node after being reset by the second reset circuit.

19. The pixel circuit according to claim 18, wherein the second reset circuit comprises a second reset transistor, a gate electrode of the second reset transistor is connected with a second reset line to receive the second reset signal, a first electrode of the second reset transistor is connected with a second reset voltage line to receive the second reset voltage, and a second electrode of the second reset transistor is connected with the second electrode of the second light emission control transistor and the light emitting element.

20. The pixel circuit according to claim 18, further comprising a third reset circuit, wherein the third reset circuit is connected with the threshold compensating circuit and the control terminal of the driving circuit, the third reset circuit is configured to apply a third reset voltage to the control terminal of the driving circuit in response to a third reset signal;
a potential of the first node after being reset by the third reset circuit is less than the potential of the third node after being reset by the first reset circuit; and
the potential of the first node after being reset by the third reset circuit is less than or equal to the potential of the fourth node after being reset by the second reset circuit.

21-23. (canceled)

24. A display panel, comprising a plurality of pixel units, wherein each pixel unit comprises the pixel circuit according to claim 14.

25. A display device, comprising the display panel according to claim 24.
